(19) United States
(12) Patent Application Publication
(10) Pub. No.: US 2015/0288974 A1
(43) Pub. Date: Oct. 8, 2015

(54) VIDEO ACQUISITION AND PROCESSING SYSTEMS

(71) Applicant: Bring Technology Inc., Vancouver (CA)

(72) Inventors: Jorge Rubinstein, Newton, MA (US); Albert Rooyakkers, Scotts Valley, CA (US); Farooq Habib, Vancouver (CA); Dimitri A. Choutov, Sunnyvale, CA (US)

(21) Appl. No.: 14/730,751

(22) Filed: Jun. 4, 2015

Related U.S. Application Data
(63) Continuation of application No. 12/546,470, filed on Aug. 24, 2009, now abandoned.
Application No. 12/546,470 is a continuation-in-part of application No. 12/322,571, filed on Feb. 4, 2009, now Pat. No. 8,660,193.
Application No. 12/322,571 is a continuation-in-part of application No. 12/319,750, filed on Jan. 12, 2009, now abandoned.

(51) Int. Cl. H04N 19/186; H04N 19/44

(52) U.S. Cl. CPC H04N 19/186; H04N 19/44

(57) ABSTRACT

Embodiments of the present invention are video acquisition and processing systems. One embodiment of the present invention, video acquisition and processing systems include a sensor, image signal processor, and video compression and decompression components fully integrated in a single integrated circuit. The integrated sensor and image signal processor feature highly parallel transmission of image data to the video compression and decompression component. This highly parallel, pipelined, special-purpose integrated-circuit implementation offers cost-effective video acquisition and image data processing and an extremely large computational bandwidth with relatively low power consumption and low-latency for processing video signals.

### CROSS-REFERENCE TO RELATED APPLICATIONS

This application is a continuation-in-part of application Ser. No. 12/322,571, filed Feb. 4, 2009, which is a continuation-in-part of U.S. application Ser. No. 12/319,750, filed Jan. 12, 2009.

### TECHNICAL FIELD

The present invention is related to efficient methods and computational devices for carrying out video acquisition and image processing.

### BACKGROUND OF THE INVENTION

Computing machinery is undergoing rapid evolution. Early electronic computers were generally entirely sequential processing machines, executing a stream of instructions, one-by-one, that together compose a computer program. For many years, electronic computers generally included a single main processor which was capable of rapidly executing a relatively small set of simple instructions, including memory-fetch, memory-store, arithmetic, and logical instructions. A computational task was addressed by programming a solution to the task as a set of instructions and then executing the program on a single-processor computer system.

Relatively early in the evolution of electronic computers, various ancillary and support tasks began to be moved, away from the main processor, to specialized auxiliary processing components. As one example, separate I/O controllers were developed for off-loading much of the repetitive and computational-bandwidth-consuming tasks associated with exchanging information between main memory and various external devices, including mass-storage devices, communications devices, display devices, and user-input devices. This incorporation of multiple processing elements into single-main-processor computer system was the beginning of a trend towards increasing parallelism in computing.

Parallel computation is currently a dominant trend in the design of modern computational machinery. At one extreme, individual processor cores often provide for concurrent, parallel execution of multiple instruction streams, and provide for assembly-line-like, concurrent execution of multiple instructions. Most computers, including personal computers, now incorporate at least two, and often many more, processor cores within each single integrated circuit. Each processor core can relatively independently execute multiple instruction streams. Electronic computer systems may contain multiple multi-core processors, and may be aggregated together into vast distributed computing networks comprising tens to thousands to hundreds of thousands of discrete computer systems that intercommunicate with one another and that each executes one or more separable portions of a large, distributed computational task.

As computers have evolved towards parallel and massively parallel computational systems, many of the most difficult and vexing problems associated with parallel computing have been found to be associated with decomposing large computational tasks into relatively independent subtasks, each of which can be carried out by a different processing entity. When problems are not properly decomposed, or when problems cannot be decomposed, for parallel execution, then employing parallel computer machinery often provides little or no benefit, and, in worst cases, may actually result in slower execution than can be obtained by a traditional software implementation executed on a single-processor computer system. When multiple computational entities contend for shared resources, or depend on computational results generated concurrently by other processing entities, enormous computational and communications resources may be expended to manage the parallel operation of the multiple computational entities. Often, the communications and computational overheads may far outweigh the benefits of a parallel-computing approach carried out on multiple processors or other computational entities. Furthermore, there may be significant financial costs involved with parallel computing, and also significant costs in power consumption and in heat dissipation.

Thus, although parallel computation appears to be the logical approach to efficient computing of many computational tasks, judging from biological systems and the evolutionary trends already encountered in the short time span of the evolution of electronic computers, parallel computing is also associated with many complexities, costs, and disadvantages. While many problems may theoretically benefit from a parallel-computing approach, the techniques and hardware for parallel computing that are currently available often cannot provide cost-effective solutions for many computational problems, particularly for complex computations that need to be carried out in real time within devices constrained by size constraints, heat-dissipation constraints, power-consumption constraints, and cost constraints. For this reason, computer scientists, electrical engineers, researchers and developers in many computationally oriented fields, manufacturers and vendors of electronic devices and electronic computers, and, ultimately, users of electronic devices and electronic computers all recognize the need for continued development of new approaches to efficient implementation of parallel computation engines for solving practical problems.

### SUMMARY OF THE INVENTION

Embodiments of the present invention are directed to parallel, pipelined, integrated-circuit implementations of sensors, image signal processors, and video encoders and decoders (“video codec”) to carry out complex computational video processing and other tasks in real time. One embodiment of the present invention is a family of video acquisition and processing systems composed of integrated sensors, image signal processors, and a video codec that can be implemented in a single integrated circuit and incorporated within cameras, handsets, and other electronic devices for video capture and processing. The video codecs are configured to encode video signals produced by the integrated sensor and image signal processor into compressed video signals for storage and transmission, and are configured to decode compressed video signals into video signals for output to display devices. A highly parallel, pipelined, special-purpose integrated-circuit implementation of a particular video acquisition and processing system provides, according to embodiments of the present invention, a cost-effective computational system with an extremely large computational bandwidth, relatively low power consumption and low-latency for image acquisition, image processing, and decompression and compression of compressed video signals and raw video signals, respectively.

### BRIEF DESCRIPTION OF THE DRAWINGS

FIG. 1 illustrates a digitally-encoded image.

FIG. 2 illustrates two different pixel-value encoding methods according to two different color-and-brightness models.

FIG. 3 illustrates digital encoding using the Y′CrCb color model.

FIG. 4 illustrates the output of a video camera.

FIG. 5 illustrates the function of a video codec.

FIG. 6 illustrates various data objects upon which video-encoding operations are carried out during video-data-stream compression and compressed-video-data-stream decompression.

FIG. 7 illustrates partitioning of a video frame into two slice groups.

FIG. 8 illustrates a second level of video-frame partitioning.

FIG. 9 illustrates the general concept of intra prediction.

FIGS. 10A-10I illustrate the nine 4×4 luma-block intra-prediction modes.

FIGS. 11A-11D illustrate, using similar illustration conventions as used in FIGS. 10A-I, the four modes for intra prediction of 16×16 luma blocks.

FIG. 12 illustrates the concept of inter prediction.

FIGS. 13A-13D illustrate the interpolation process used to compute pixel values for blocks, within a search space of a reference frame, that can be thought of as occurring at fractional coordinates.

FIGS. 14A-14C illustrate the different types of frames and some different types of inter prediction possible with respect to those frames.

FIG. 15 illustrates generation of difference macroblocks.

FIG. 16 illustrates motion-vector and intra-prediction-mode prediction.

FIG. 17 illustrates decomposition, integer transformation, and quantization of a difference macroblock.

FIG. 18 provides derivation of the integer transform and inverse integer transform employed in H.264 video compression and video decompression, respectively.

FIG. 19 illustrates the quantization process.

FIG. 20 provides a numerical example of entropy encoding.

FIGS. 21A-21B provide an example of arithmetic encoding.

FIGS. 22A-22B illustrate one commonly occurring artifact and a filtering method that is used, as a final step in decompression, to ameliorate the artifact.

FIG. 23 summarizes H.264 video-data-stream encoding.

FIG. 24 illustrates, in a block diagram fashion similar to that used in FIG. 23, the H.264 video-data-stream decoding process.

FIG. 25 illustrates a very high-level diagram of a sensor electronically to a processor and other components on a circuit board of a typical video camera.

FIG. 26 is a very high-level diagram of a general purpose computer.

FIGS. 27A-27B illustrate a high-level schematic representation of a sensor, image signal processor (“ISP”), and video codec of video acquisition and processing system-on-a-chip implementation employed in a video-camera system according to the present invention.

FIG. 28 illustrates a schematic representation of a video acquisition and processing system configured according to the present invention.

FIGS. 29A-29C illustrates schematic representations of two video acquisition and processing systems configured according to the present invention.

FIG. 30 illustrates a schematic diagram of a sensor/ISP configured according to embodiments.

FIG. 31 illustrates an exploded isometric view of a sensor configured according to the present invention.

FIG. 32 illustrates an exploded isometric view of a portion of a color filter array and a corresponding portion of a sensor element array according to the present invention.

FIG. 33 illustrates a diagram of the sensor operated in accordance with embodiments of the present invention.

FIG. 34A illustrates four possible cases for interpolating red and blue color values from the color values of nearest neighboring pixels according to the present invention.

FIG. 34B illustrates two cases for interpolating green color values for pixels with red and blue color values form the color values of nearest neighboring pixels according to the present invention.

FIG. 35 illustrates a diagram of the sensor operated to retrieve rows of macroblocks in accordance with embodiments of the present invention.

FIG. 36 illustrates a schematic representation of a sense module configured according to the present invention.

FIG. 37 illustrates a number of aspects of the video compression and decompression process that, when considered, provide insight into a new, and far more computationally efficient, approach to implementation of a video codec according to the present invention.

### DETAILED DESCRIPTION OF THE INVENTION

Embodiments of the present invention are directed to providing cost-effective video acquisition and processing systems to capture images, perform image signal processing and carry out complex computational video processing and other tasks in real time with low power consumption, low heat-dissipation requirements, large computational bandwidths, and low latency for task execution. Video acquisition and processing systems configured in accordance with embodiments of the present invention include an integrated sensor and image signal processor that, in certain embodiments, are fully integrated in a single integrated circuit with a video codec. The integrated sensor and image signal processor feature highly parallel transmission of image data to the video codec within the same integrated circuit. In other embodiments, the sensor and image signal processor can be fully integrated in a first integrated circuit and the video codec can be implemented in a second integrated circuit with the first and second integrated circuits in electrical communication over a circuit board. The circuit board can be configured with data lines enabling highly parallel transmission of image data from the first integrated circuit to the second integrated circuit. The video codec can be implemented with computational engines, which are individual integrated circuits, or chips, that feature highly parallel computation provided by many concurrently operating processing elements according to the present invention. Effective use of the currently executing processing elements is made possible by a suitable decomposition of a complex computational task, efficient access to shared information and data objects within the integrated circuit, and efficient, hierarchical control of processing tasks and subtasks.

Various alternative embodiments of the video acquisition and processing systems may be employed in a wide variety of electronic devices and handsets, including mobile phones equipped with video cameras, digital video cameras, personal computers, surveillance equipment, remote sensors, aircraft and spacecraft, and a wide variety of other types of equipment.

The following discussion is organized as two subsections: (1) The H.264 Compressed-Video-Signal-Decompression Standard; and (2) Principles of Parallel Integrated-Circuit Design for Addressing Complex Computational Tasks in Video Acquisition and Processing Systems According to the Present Invention. It should be noted that while the examples herein are primarily presented using the H.264 standard, it should be understood that these are just examples and the invention is in no way restricted to H.264 implementations. In the first subsection, below, the computational task carried out by a specific example of a parallel, pipelined, integrated-circuit computational engine is described, in overview. The specific described embodiment is a video acquisition and processing system that compresses raw video signals and decompresses compressed video signals according to the H.264, or MPEG-4 AVC, compressed-video-signal decompression standard. For those readers already familiar with the H.264 compressed-video-signal-decomposition standard, the first subsection can be skipped.

### Subsection I

### The H.264 Compressed-Video-Signal-Decompression Standard

This first subsection provides an overview of the H.264 compressed-video-signal decompression standard. This subsection provides a description of the computational problem addressed by a specific embodiment of a parallel, pipelined, integrated-circuit computational engine that represents an embodiment of the present invention. Those readers familiar with H.264 may skip this first subsection, and continue with the second subsection, below.

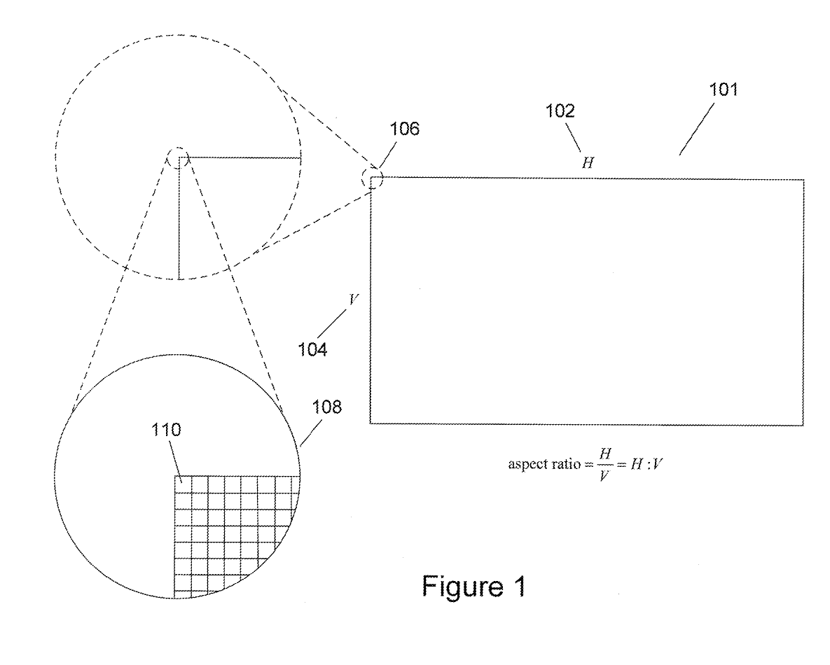

FIG. 1 illustrates a digitally-encoded image. A digitally-encoded image can be a still, photograph, a video frame, or any of various graphical objects. In general, a digitally-encoded image comprises a sequence of digitally encoded numbers that together describe a rectangular image 101. The rectangular image has a horizontal dimension 102 and a vertical dimension 104, the ratio of which is referred to as the “aspect ratio” of the image.

A digitally-encoded image is decomposed into tiny display units, referred to as “pixels.” In FIG. 1, a small portion 106 of the left, upper corner of a displayed image is shown twice magnified. Each magnification step is a 12-fold magnification, producing a final 144-fold magnification of a tiny portion of the left upper corner of the digitally-encoded image 108. At 144-fold magnification, the small portion of the displayed image is seen to be divided into small squares by a rectilinear coordinate grid, each small square, such as square 110, corresponding to, or representing, a pixel. A video image is digitally encoded as a series of data units, each data unit describing the light-emission characteristics of one pixel within the displayed image. The pixels can be thought of as cells within a matrix, with each pixel location described by a horizontal coordinate and a vertical coordinate. The pixels can alternatively be considered to be one long linear sequence of pixels, produced in raster-scan order, or in some other predefined order. In general, a logical pixel in a digitally-encoded image is relatively directly translated into light emission from one or several tiny display elements of a display device. The number that digitally encodes the value of each pixel is translated into one or more electronic voltage signals to control the display unit to emit light of a proper hue and intensity so that, when all of the display units are controlled according to the pixel values encoded in a digitally-encoded image, the display device faithfully reproduces the encoded image for viewing by a human viewer. Digitally-encoded images may be displayed on cathode-ray-tube, LCD, or plasma display devices incorporated within televisions, computer display monitors, and other such light-emitting display devices, may be printed onto paper or synthetic films by computer printers, may be transmitted through digital communications media to remote devices, may be stored on mass-storage devices and in computer memories, and may be processed by various image-processing application programs.

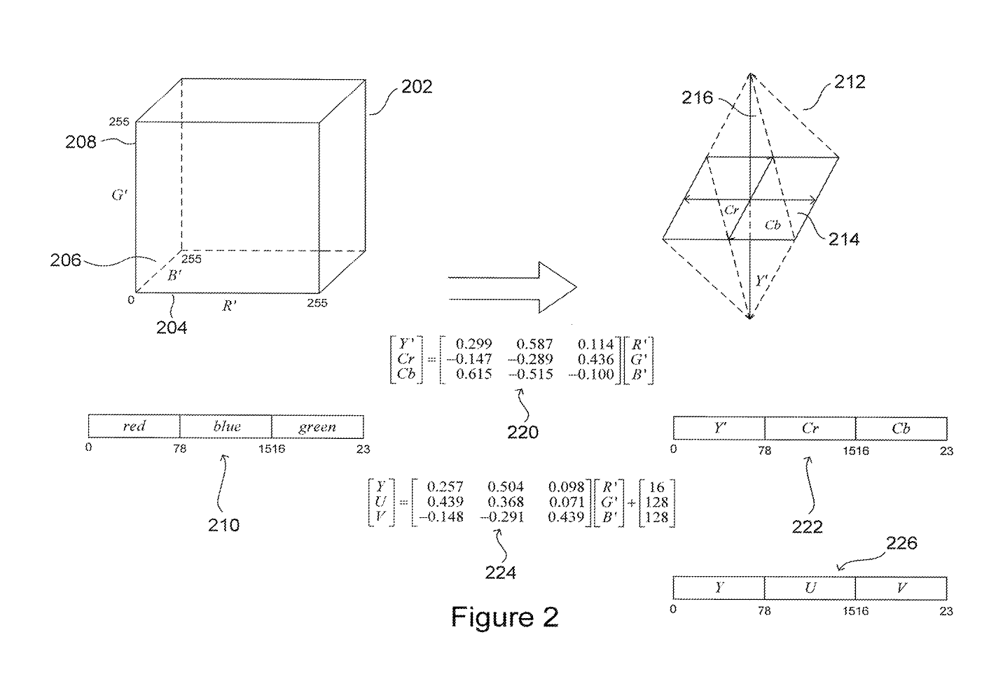

There are various different methods and standards for encoding color and emission-intensity information into a data unit. FIG. 2 illustrates two different pixel-value encoding methods according to two different color-and-brightness models. A first color model 202 is represented by a cube. The volume within the cube is indexed by three orthogonal axes, the R′ axis 204, the B′ axis 206, and the G′ axis 208. In this example, each axis is incremented in 256 increments, corresponding to all possible numeric values of an eight-bit byte, with alternative. R′G′B′ models using a fewer or greater number of increments. The volume of the cube represents all possible color-and-brightness combinations that can be displayed by a pixel of a display device. The R′, B′, and G′ axes correspond to red, blue, and green components of the colored light emitted by a pixel. The intensity of light emission by a display unit is generally a non-linear function of the voltage supplied to the data unit. In the RGB color model, a G-component value of 127 in a byte-encoded G component would direct one-half of the maximum voltage that can be applied to a display unit to be applied to a particular display unit. However, when one-half of the maximum voltage is applied to a display unit, the brightness of emission may significantly exceed one-half of the maximum brightness emitted at full voltage. For this reason, a non-linear transformation is applied to the increments of the RGB color model to produce increments of the R′G′B′ color model, so that the scaling is linear with respect to perceived brightness. The encoding for a particular pixel 210 may include three eight-bit bytes, for a total of 24 bits, when up to 256 brightness levels can be specified for each of the red, blue, and green components of the light emitted by a pixel. When a larger number of brightness levels can be specified, a larger number of bits is used to represent each pixel, and when a lower number of brightness levels are specified, a smaller number of bits may be used to encode each pixel.

Although the R′G′B′ color model is relatively easy to understand, particularly in view of the red-emitting-phosphor, green-emitting-phosphor, and blue-emitting-phosphor construction of display units in CRT screens, a variety of related, but different, color models are more useful for video-signal compression and decompression. One such alternative color model is the Y′CrCb color model. The Y′CrCb color model can be abstractly represented as a bi-pyramidal volume 212 with a central, horizontal plane 214 containing orthogonal Cb and Cr axes, with the long, vertical axis of the bi-pyramid 216 corresponding to the Y′ axis. In this color model, the Cr and Cb axes are color-specifying axes, with the horizontal mid-plane 214 representing all possible hues that can be displayed, and the Y′ axis represents the brightness or intensity at which the hues are displayed. The numeric values that specify the red, blue, and green components in the R′G′B′ color model can be directly transformed to equivalent Y′CrCb values by a simple matrix transformation 220. Thus, when eight-bit quantities are used to encode the Y′, Cr, and Cb components of display-unit emission according to the Y′CrCb color model, a 24-bit data unit 222 can be used to encode the value for a single pixel. A second color model is the YUV color model. The YUV color model can also be abstractly represented by the same bi-pyramidal volume 212 with the central, horizontal plane 214 containing orthogonal U and V axes, with the long, vertical axis of the bi-pyramid 216 corresponding to the Y axis. The numeric values that specify the red, blue, and green components in the R′G′B′ color model can be directly transformed to equivalent YUV values by a second matrix transformation 224. When eight-bit quantities are used to encode the Y, U, and V components of display-unit emission according to the YUV color model, a 24-bit data unit 226 can also be used to encode the value for a single pixel.

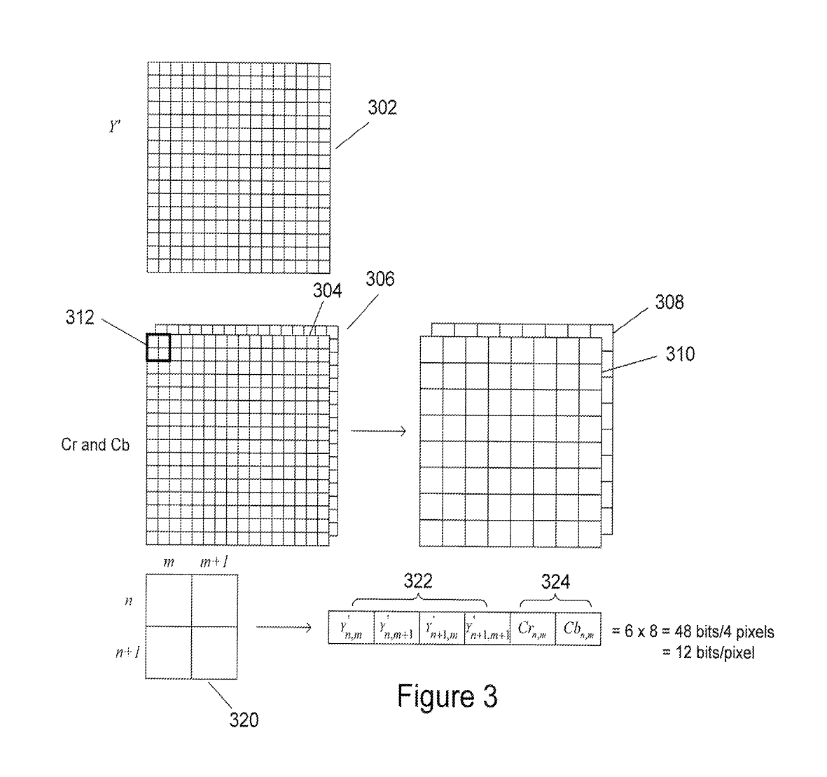

For image processing, when the Y′CrCb color model is employed, a digitally-encoded image can be thought of as three separate pixilated planes, superimposed one over the other. FIG. 3 illustrates digital encoding using the Y′CrCb color model. A digitally-encoded image, as shown in FIG. 3, can be considered to be a Y′ image 302 and two chrome images 304 and 306. The Y′ plane 302 essentially encodes the brightness values of the image, and is equivalent to a monochrome representation of the digitally-encoded image. The two chroma planes 304 and 306 together represent the hue, or color, at each point in the digitally-encoded image. In other words, each pixel is stored as a single Y value, a single Cr value, and a single Cb value. This type of image encoding is referred to as Y′CrCb (4:4:4). For many video-processing and video-image-storage purposes, it is convenient to decimate the Cr and Cb planes to produce Cr and Cb planes 308 and 310 with one-half resolution. In other words, rather than storing an intensity and two chroma values for each pixel, an intensity value is stored for each pixel, but a pair chroma values is stored for each 2×2 square containing four pixels. This type of image encoding is referred to as Y′CrCb (4:2:2). For example, all four pixels in the left upper corner of the image 312 are encoded to have the same Cr value and Cb value. For each 2×2 region of the image 320, the region can be digitally encoded by four intensity values 322 and two chroma values 324, 48 bits in total, or, in other words, by using 12 bits per pixel. Using one quarter as many chroma values as luma values is referred to as Y′CrCb (4:2:0).

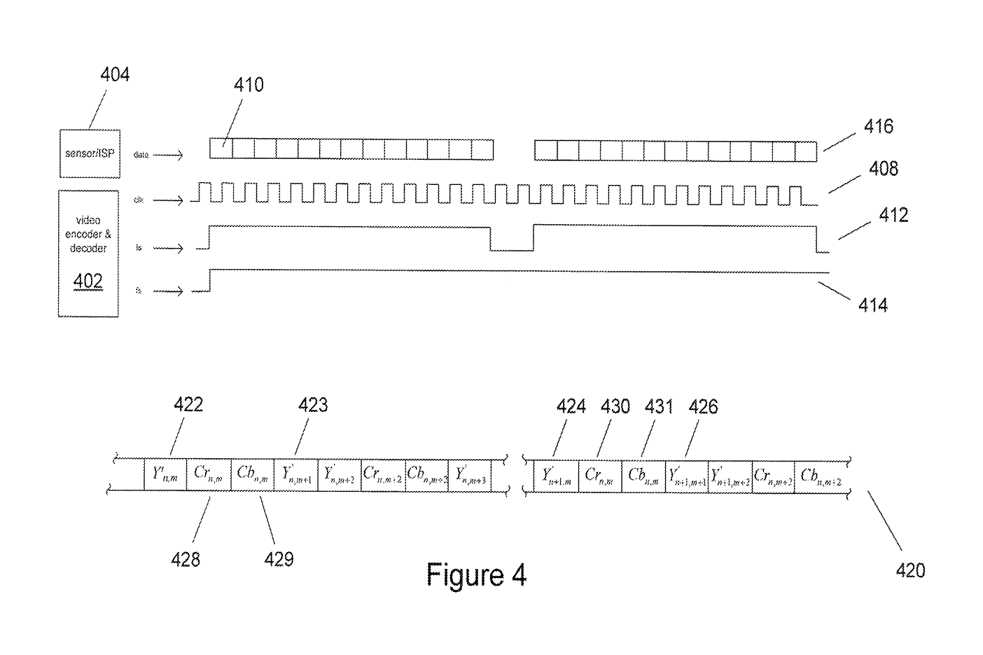

FIG. 4 illustrates the output of an integrated sensor and image signal processor (“sensor/ISP”) 402 and a video codec 404 described in subsection II, below. The sensor/ISP 402 produces data packets, such as data packet 410, and the video codec 402 produces a clock signal 408, the rising edges of each pulse of which correspond to the beginning of a next data packet, such as data packet 410. In the example shown in FIG. 4, each data packet contains an eight-bit intensity or chroma value. The video codec also produces a line, or row signal 412, with the signal high over a period of time corresponding to output of an entire row of a digitally-encoded image. The video codec additionally outputs a frame signal 414, which is high over a period of time during which one digital image, or frame, is output. The clock, row, and frame output signals together specify the times for the output of each intensity or chroma value, the output of each row of a frame, and the output of each frame in a video signal. The data output 416 of the sensor/ISP is shown, in greater detail, as the sequence of Y′CrCb (4:2:2) data packets 420 at the bottom of FIG. 4. The sensor/ISP is not limited to having a row and frame signal output. In other embodiments, the sensor/ISP 402 may have output with vsync and hsync coordinates that correspond to row and column of the sensor. Referring to the 2×2 pixel region (320 in FIG. 3) shown in FIG. 3, and using the same indexing conventions as used with respect to that region for the encoded intensity and chroma values 322 and 324 in FIG. 3, the contents of the stream of data 420 in FIG. 4 can be understood. Two intensity values for a 2×2 square region of pixels 422-426 are transmitted, along with a first set of two chroma values 428-429 for the 2×2 square region of pixels, as part of a first row of pixel values, with the two chroma values 428-429 transmitted in between the first two intensity values 422-423. Subsequently, the chroma values are repeated 430-431 between the second pair of intensity values 424 and 426 as part of a next row of pixel intensities. The repetition of chroma values facilitates certain types of real-time video-data-stream processing. However, the second pair of chroma values 430-431 is redundant. As discussed with respect to FIG. 3, the chroma planes are decimated, so that only two chroma values are associated with each 2×2 region containing four pixels.

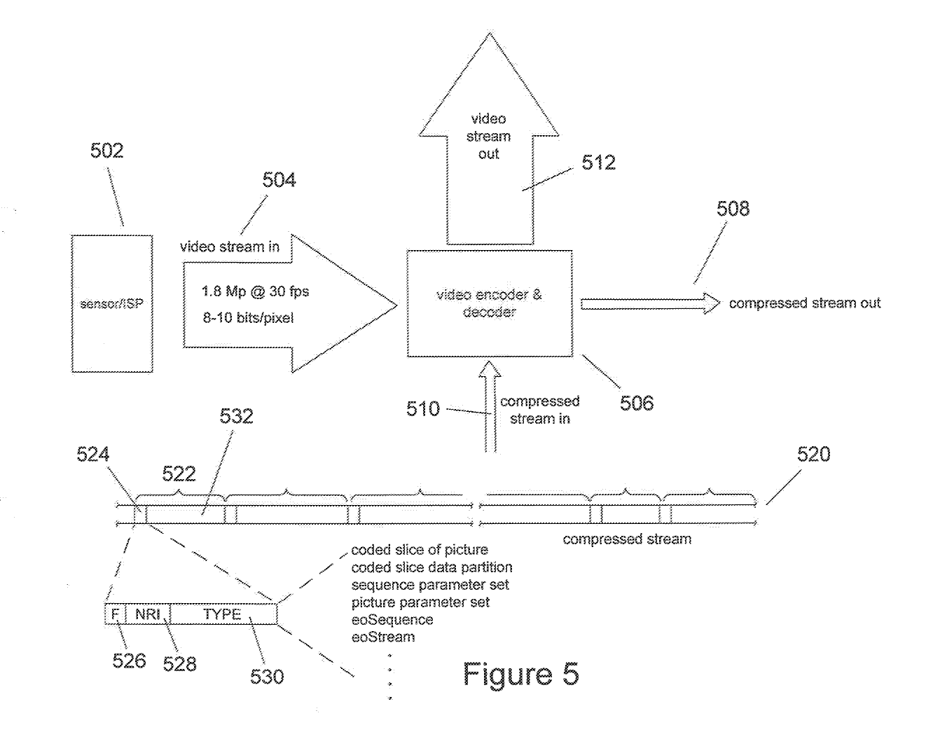

FIG. 5 illustrates the function of a sensor/ISP and a video codec of a video acquisition and processing system. As discussed above, with reference to FIGS. 1-4, a sensor/ISP 502 produces a stream of digitally encoded video frames 504. The sensor/ISP 502 can be configured to produce between about 30 to about 60 frames per second. Thus, at 30 frames per second, assuming frames of 1920×1080 pixels, and assuming an encoding that uses 12 bits per pixel, the sensor/ISP produces about 93 megapixels per second or about 140 megabytes/s for a (4:2:2) format. Small, hand-held electronic devices manufactured according to currently-available designs and technologies cannot process, store, and/or transmit data at this rate. In order to produce manageable data-transfer rates, a video codec 506 is employed to compress the data stream output from the sensor/ISP. For example, the H.264 standard provides for video compression ratios of about 30:1. The incoming 93 MB/s data stream from the sensor/ISP is thus compressed, by the video codec 506, to produce a compressed video data stream of about 3 MB/s 508. By contrast to the raw video-data stream produced by the sensor/ISP, the compressed video-data stream is output by the video codec at a data rate that can be processed for storage or transmission by a hand-held device. A video codec can also receive a compressed video-data stream 510 and decompress the compressed data to produce an output raw video-data stream 512 for consumption by a video-display device.

The 30:1 compression ratio can be achieved by a video codec because video signals generally contain relatively large amounts of redundant information. As one example, a video signal generated by filming two children throwing a ball back and forth contains a relatively small amount of rapidly changing information, namely the images of the children and the ball, and a relatively large amount of static or slowly changing objects, including the background landscape and lawn upon which the children are playing. While the children's figures and the image of the ball may significantly change, from frame to frame, over the course of the filming, background objects may remain relatively constant throughout the filming, or at least for relatively long periods of time. In this case, much of the information encoded in frames subsequent to the first frame may be quite redundant. Video compression techniques are used to identify and efficiently encode the redundant information, and to therefore greatly decrease the total amount of information that is included in a compressed video signal.

The compressed video stream 508 is shown, in greater detail 520 in the lower portion of FIG. 5. According to the H.264 standard, the compressed video stream comprises a sequence of network-abstraction-layer (“NAL”) packets, such as NAL packet 522. Each NAL packet includes an 8-bit header, such as header 524 of NAL packet 522. A first bit must always be zero 526, the next two bits 528 indicate whether or not the data contained in the packet are associated with a reference frame, and the final five bits 530 together compose a type field, which indicates the type of packet and the nature of its data payload. Packet types include packets that contain encoded pixel data and encoded metadata that describes how portions of the data have been encoded, and also include packets that represent various types of delimiters, including end-of-sequence end-of-stream delimiters. The body of a NAL packet 532 generally contains encoded data.

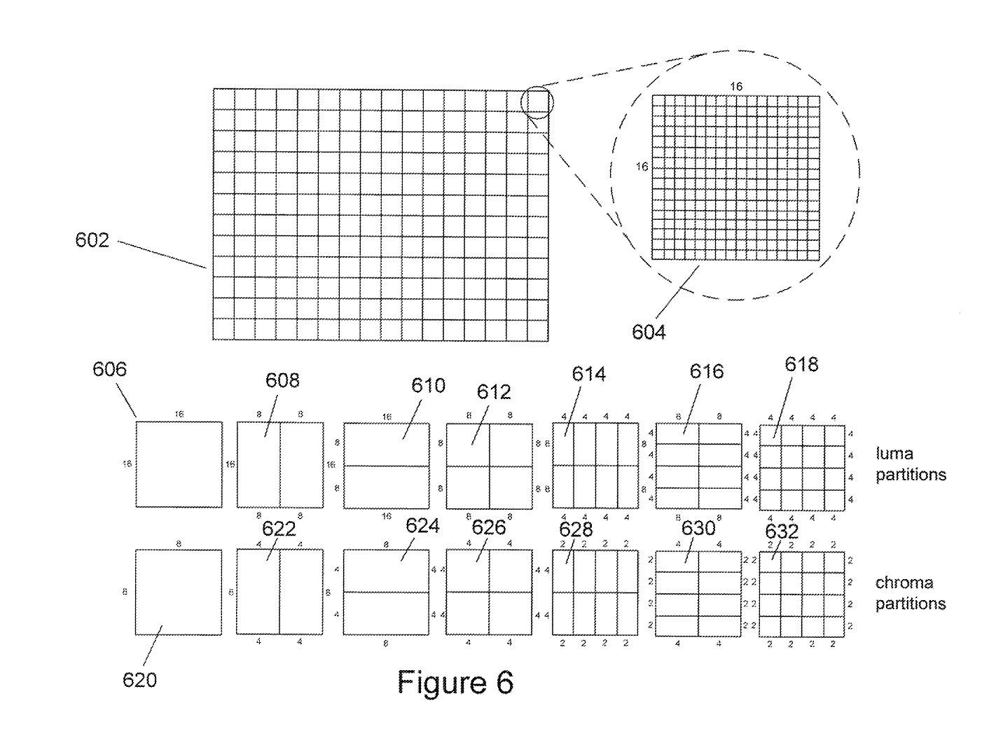

FIG. 6 illustrates various data objects upon which video-encoding operations are carried out during video-data-stream compression and compressed-video-data-stream decompression. From the standpoint of video processing, a video frame 602 is considered to be composed of a two-dimensional array of macroblocks 604, each macroblock comprising a 16×16 array of data values. As discussed above, video compression and decompression generally operate independently on Y′ frames containing intensity values and chroma frames containing chroma values. The human eye is generally far more sensitive to variations in brightness than to spatial variation in color. Therefore, a first useful compression is obtained simply by decimating two chroma planes, as discussed above. Prior to decimation, a 2×2 square of pixels can be represented by 12 bytes of encoded data, assuming eight-bit representations of intensity and chroma values. Following decimation, the same 2×2 square of four pixels can be represented by only six bytes of data. Thus, by decreasing the spatial resolution of the color signal, a compression ratio of 2:1 is achieved. While macroblocks are the basic unit on which compression and decompression operations are carried out, macroblocks may be further partitioned for certain compression and decompression operations. The intensity, or luma, macroblocks each contain 256 pixels 606, but can be partitioned to produce 16×8 partitions 608, 8×16 partitions, 8×8 partitions 612, 8×4 partitions 614, 4×8 partitions 616, and 4×4 partitions 618. Similarly, chroma macroblocks each contain 64 encoded chroma values 620, but can be further partitioned to produce 8×4 partitions 622, 4×8 partitions 624, 4×4 partitions 626, 4×2 partitions 628, 2×4 partitions 630, and 2×2 partitions 632. In addition, 1×4, 1×8, and 1×16 pixel vectors may be employed in certain operations.

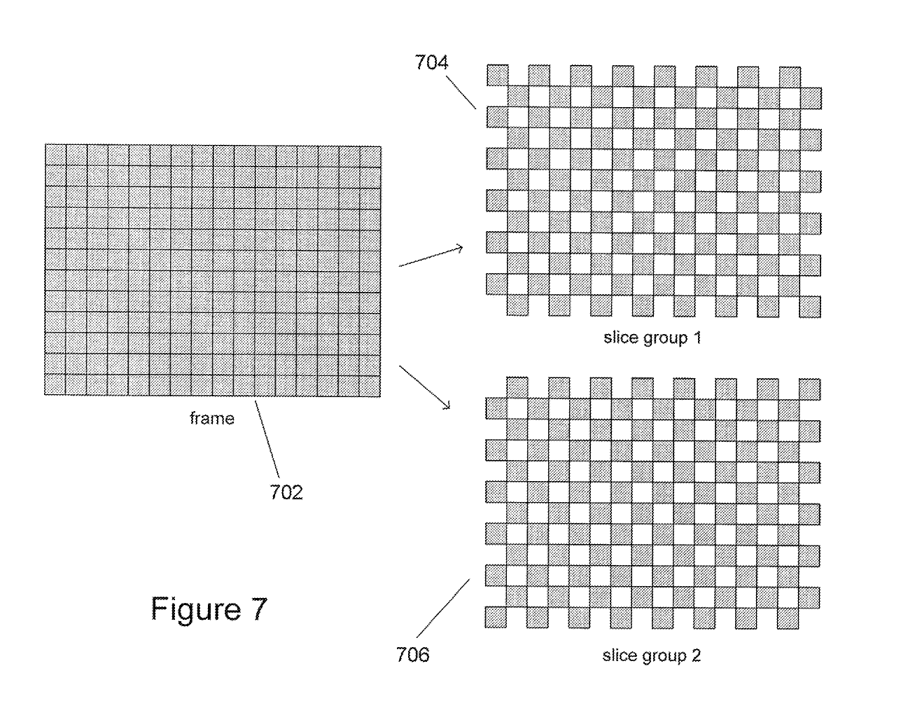

According to the H.264 standard, each video frame can be logically partitioned into slice groups, with the partitioning specified by a slice-group map. Many different types of slice-group partitioning can be specified by an appropriate slice-group map. FIG. 7 illustrates partitioning of a video frame into two slice groups. The video frame 702 is partitioned into a first, checkerboard-like slice group 704 and a complementary checkerboard-like slice group 706. The first slice group and the second slice group both contain an equal number of pixel values, and each contains one-half of the total number of pixel values in the frame. The frame can be partitioned into an essentially arbitrary number of slice groups, each including an essentially arbitrary fraction of the total pixels, according to essentially arbitrary mapping functions.

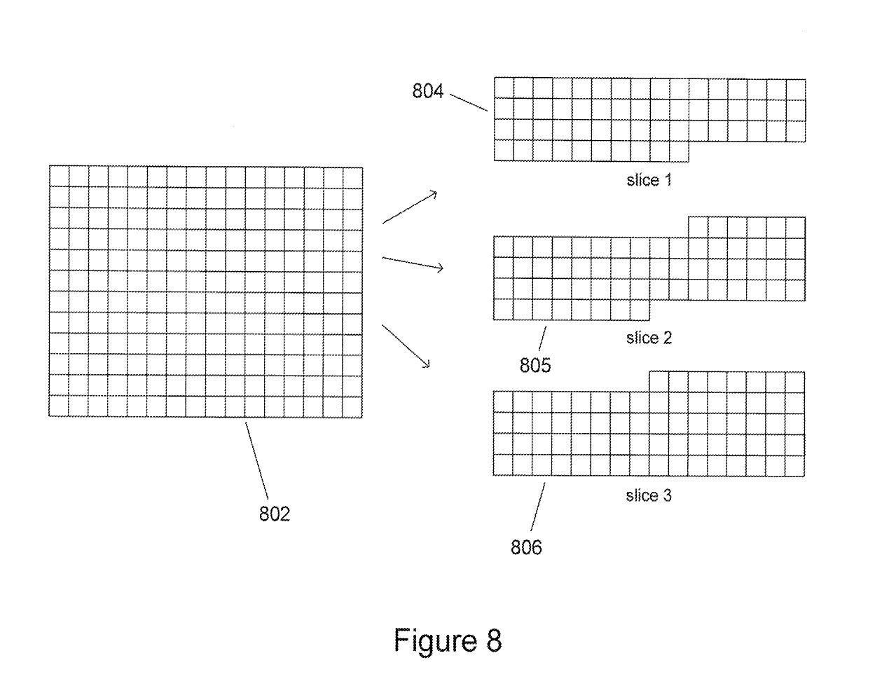

FIG. 8 illustrates a second level of video-frame partitioning. Each slice group, such as slice group 802, can be partitioned into a number of slices 804-806. Each slice contains a number of contiguous pixels (contiguous within the slice group, but not necessarily within a frame) in raster-scan order. The slice group 802 may be an entire video frame or may be a partition of the frame according to an arbitrary slice-group-partitioning function. Certain of the compression and decompression operations are carried out on a slice-by-slice basis.

To summarize, video compression and decompression techniques are carried out on video frames and various subsets of video frames, including slices, macroblocks, and macroblock partitions. In general, intensity-plane or luma-plane objects are operated on independently from chroma-plane objects. Because chroma planes are decimated by a factor of two in each dimension, with an overall 4:1 compression, the dimensions of chroma macroblocks and macroblock partitions in each dimension are generally one-half those of the luma macroblocks and luma-macroblock partitions.

A first step in video compression, as implied by the H.264 standard, is to employ one of two different general prediction techniques in order to predict the pixel values of a currently considered macroblock or macroblock partition from, in one case, neighboring macroblocks or macroblock partitions in the same frame and, in the other case; spatially neighboring macroblocks or macroblock partitions that occur in frames that precede or follow the frame of the macroblock or macroblock partition that is being predicted. The first type of prediction is spatial prediction, referred to as “intra prediction.” A second type of prediction is temporal prediction, referred to as “inter prediction.” Intra prediction is the only type of prediction that can be used for certain frames, referred to as “reference frames.” Intra prediction is also the default prediction used when encoding macroblocks. For a macroblock of a non-reference frame, inter prediction is first attempted. When inter prediction succeeds, then intra prediction is not used for the macroblock. However, when inter prediction fails, then intra prediction may be employed as the default prediction method.

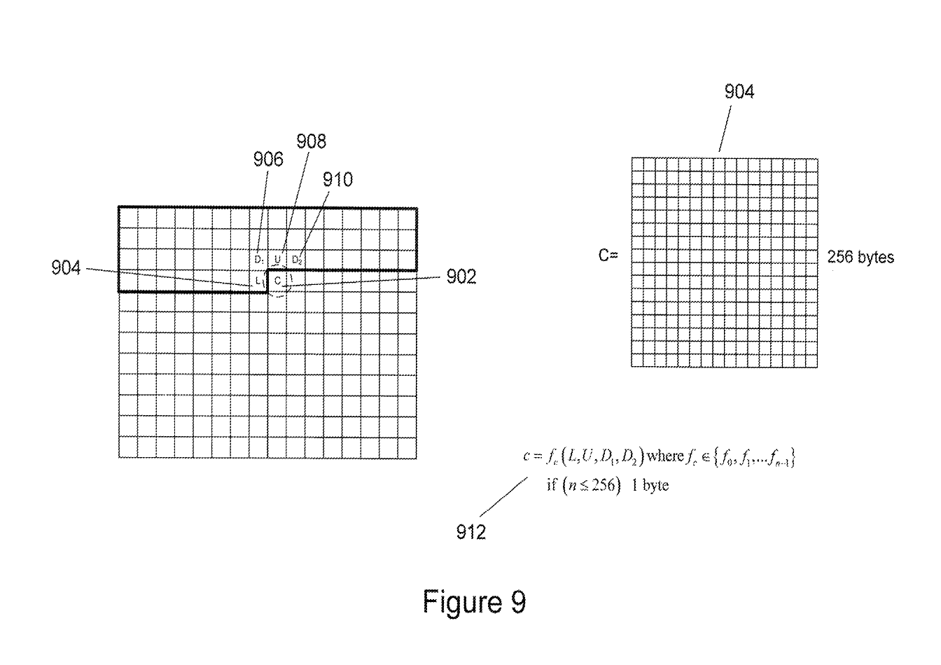

FIG. 9 illustrates the general concept of intra prediction. Consider a macroblock C 902 encountered during macroblock-by-macroblock compression of a video frame. As discussed above, a 16×16 luma macroblock 904 can be encoded using 256 bytes. However, were it possible to compute the contents of the macroblock from adjacent macroblocks in the image, then a rather large amount of compression is theoretically possible. For example, consider four adjacent macroblocks to the currently considered macroblock C 902. These four macroblocks include a left macroblock 904, an upper left diagonal macroblock 906, an upper macroblock 908, and an upper right diagonal macroblock 910. Were it possible to compute the pixel values in C 902 as a function of one or more of these adjacent macroblocks, using one of some number of different prediction functions f_{c} 912, then the contents of the macroblock could be encoded simply as a numeric designator or specifier for the prediction function. Were the number of prediction functions less than or equal to 256, for example, then the designator or specifier for the selected prediction function could be encoded in a single byte of information. Thus, were it possible to exactly compute the contents of a macroblock from its neighbors using a selected one of 256 possible prediction functions, the rather spectacular compression ratio of 256:1 could be achieved. Unfortunately, compression ratios of this magnitude are not generally achieved by the spatial-prediction methods employed for H.264 compression, because there are far too many possible macroblocks to allow for accurate prediction by only 256 prediction functions. For example, when each pixel is encoded by 12 bits, there are 2¹²=4096 different possible pixel values and 4096²⁵⁶ different possible macroblocks. However, intra prediction can significantly contribute to the overall compression ratio for H.264 video compression, particularly for relatively static video signals with large image regions that do not quickly change and that are relatively homogeneous in intensity and color.

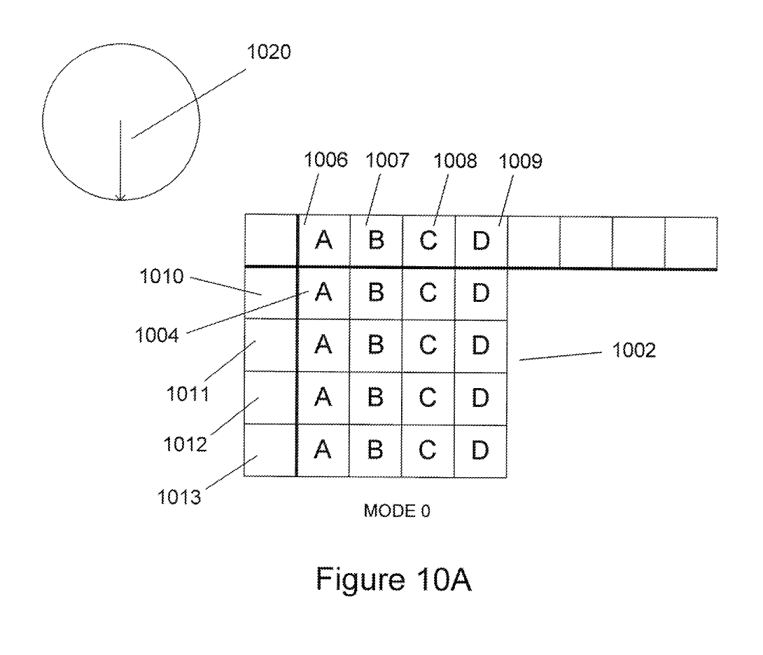

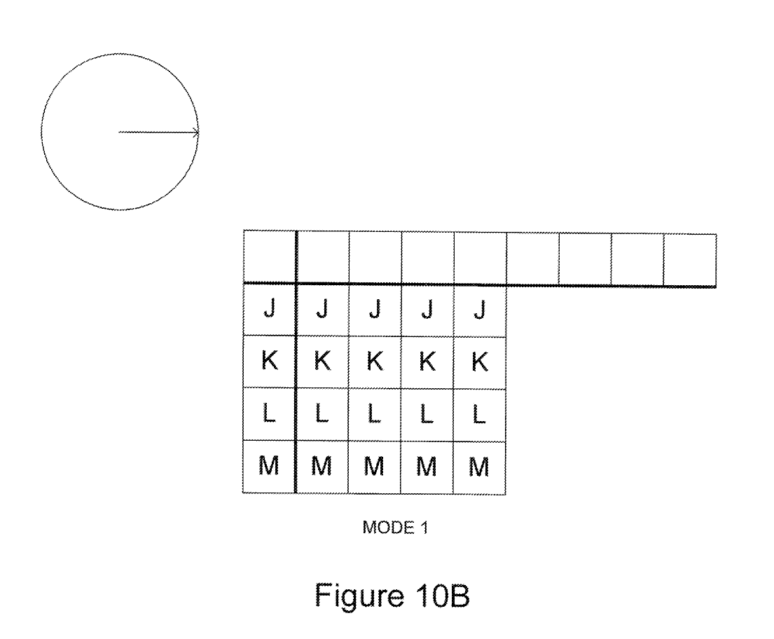

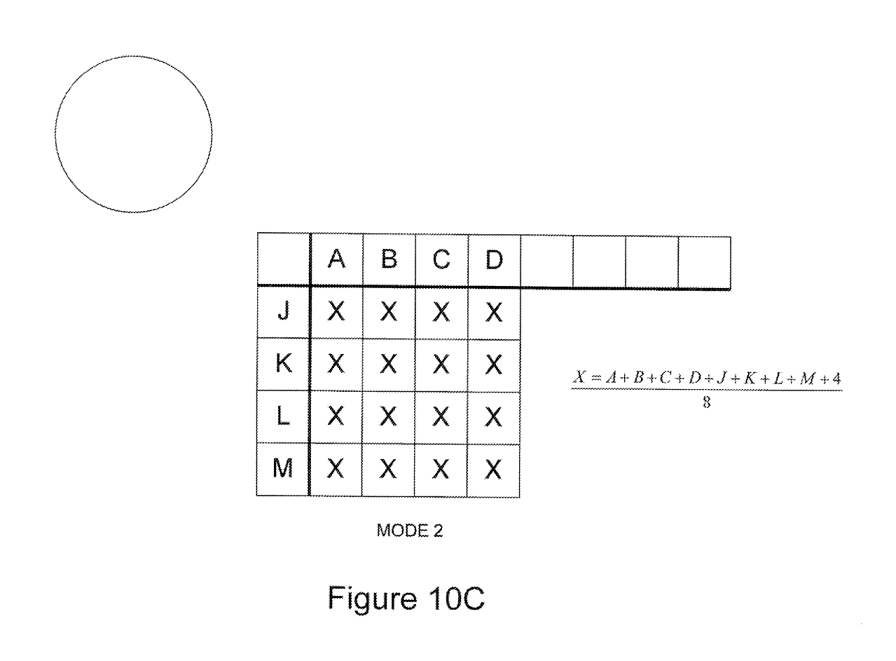

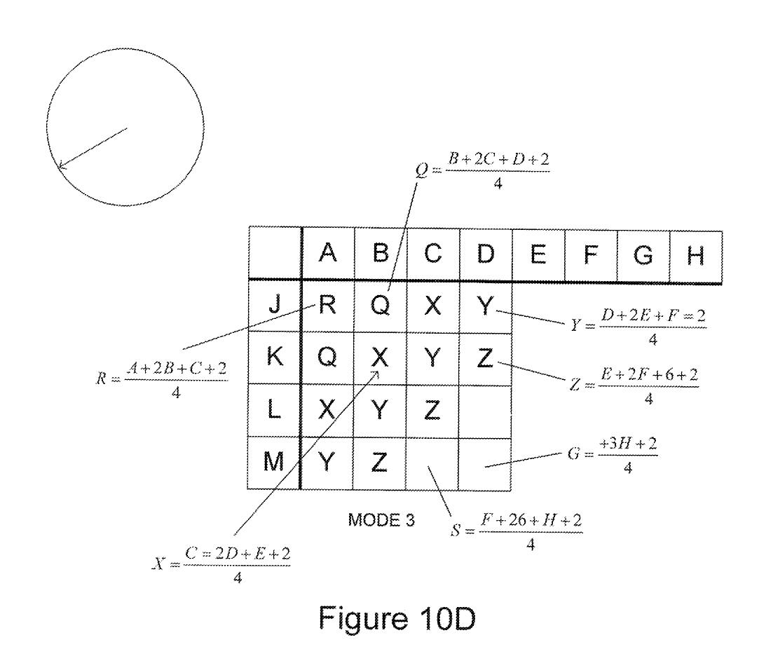

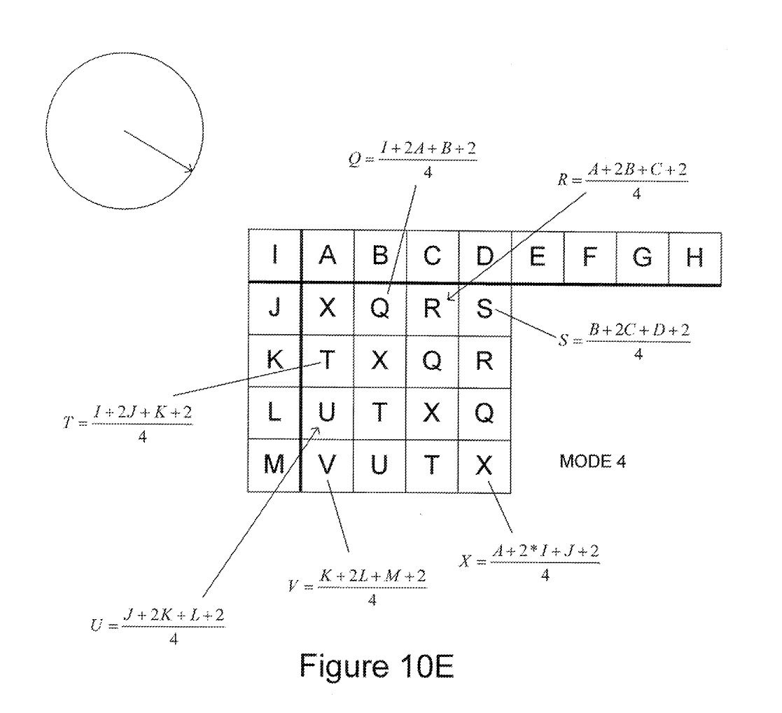

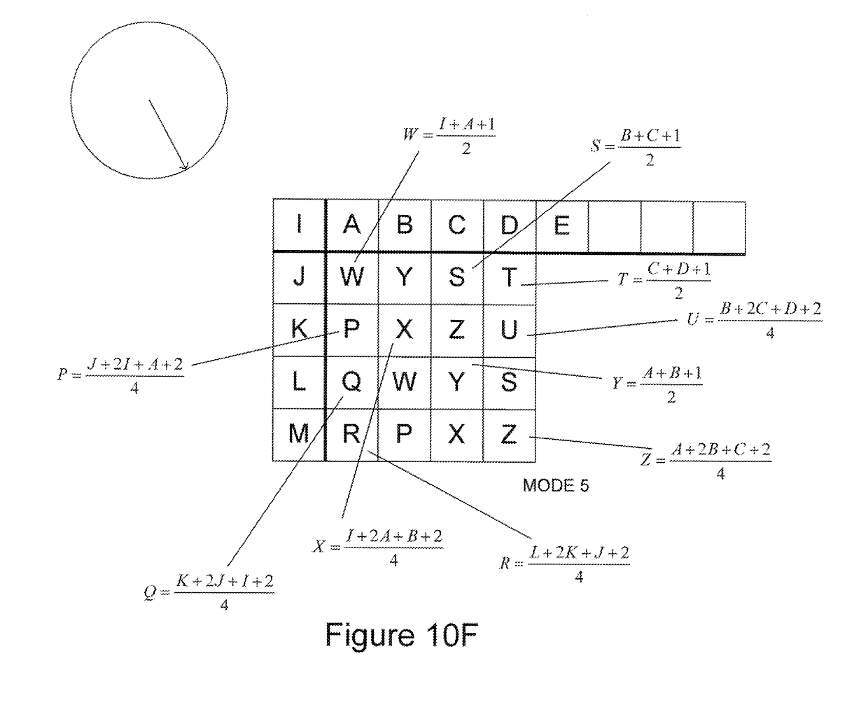

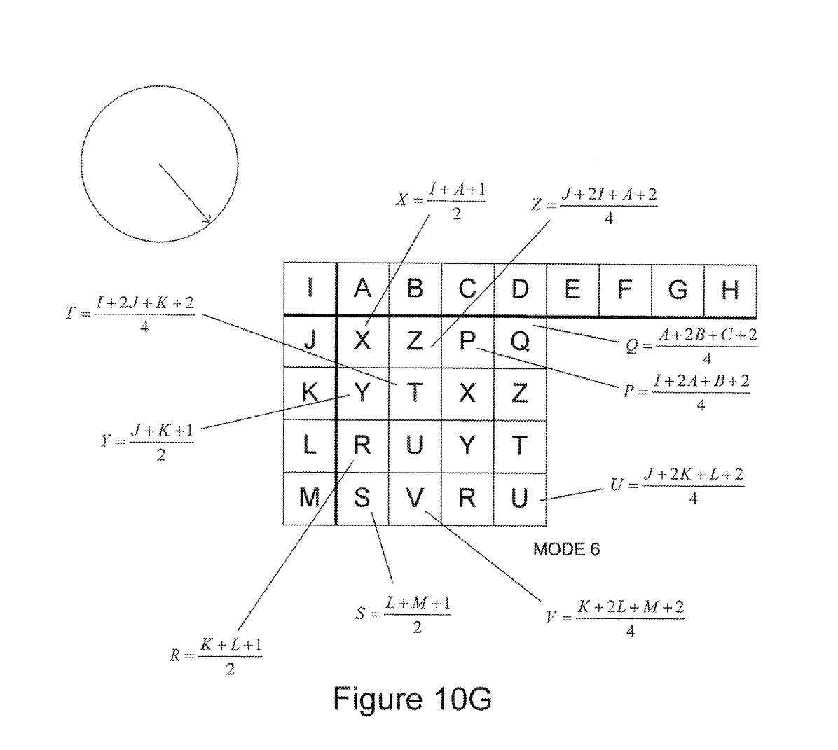

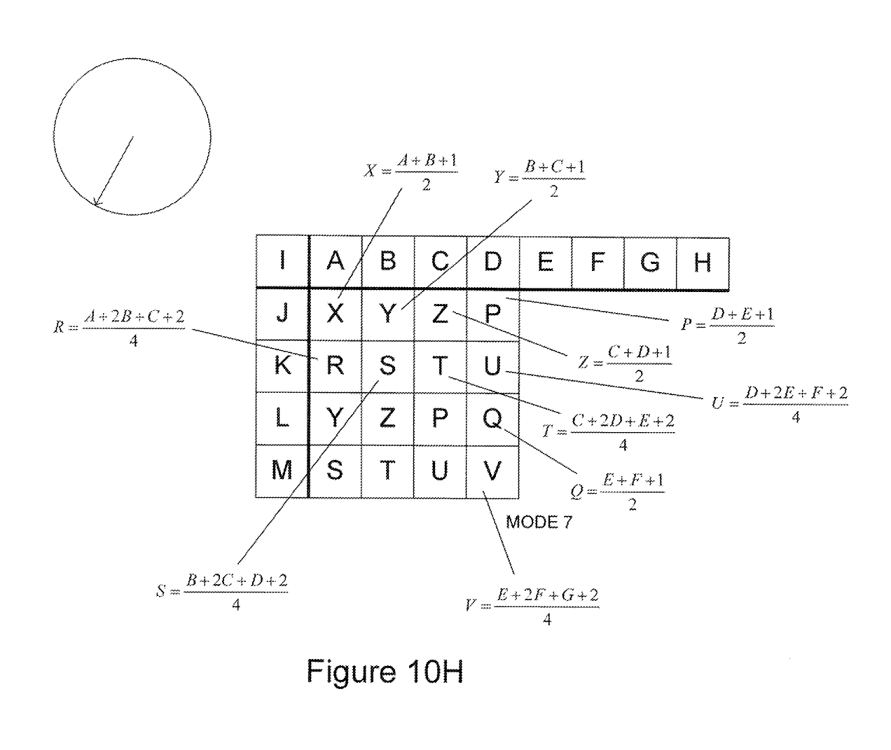

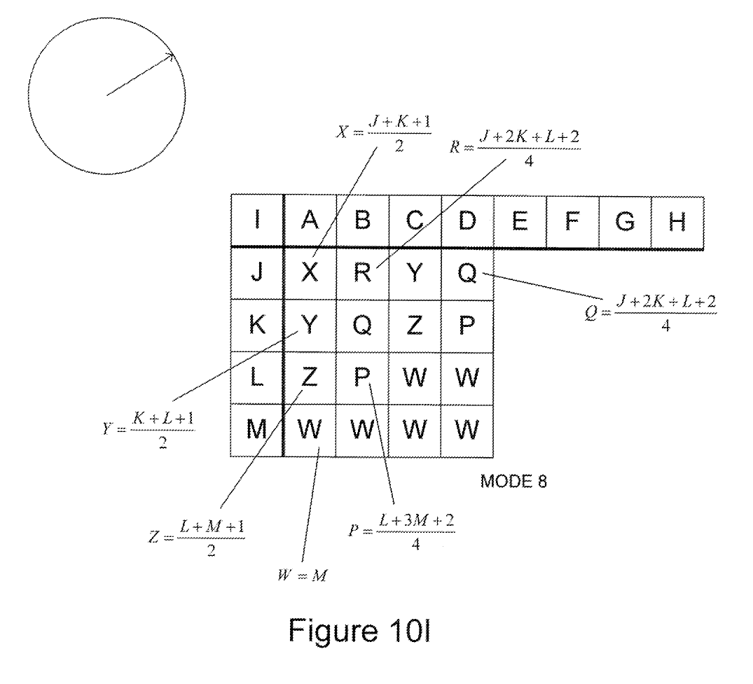

H.264 intra prediction can be carried out according to nine different modes for 4×4 luma macroblocks or according to four different modes for 16×16 luma macroblocks. FIGS. 10A-I illustrate the nine 4×4 luma-block intra-prediction modes. Illustration conventions used in all of these figures are similar, and are described with reference to FIG. 10A. The 4×4 luma macroblock that is being predicted is represented, in the figures, by the 4×4 matrix 1002 to the lower right of the diagram. Thus, the uppermost left-hand pixel value 1004 in the 4×4 matrix being predicted, in FIG. 10A, contains the value “A.” The cells adjacent to the 4×4 luma block represent pixel values in neighboring 4×4 luma blocks within the image. For example, in FIG. 10A, the values “A” 1006, “B” 1007, “C” 1008, and “D” 1009 are data values contained in the 4×4 luma block directly above the 4×4 luma block being predicted 1002. Similarly, the cells 1010-1013 represent pixel values within a last vertical column of the 4×4 luma block to the left of the 4×4 luma block being predicted. In the case of mode-0 prediction, illustrated in FIG. 10A, the values in the last row of the upper, adjacent 4×4 luma block are copied vertically downward into the columns of the currently considered 4×4 luma block 1002. Thus, in FIG. 10A, mode-0 prediction constitutes a downward, vertical prediction represented by the downward directional arrow 1020 shown in FIG. 10A. The remaining eight intra prediction modes for predicting 4×4 luma blocks are shown in FIGS. 10B-101, using the same illustration conventions as used in FIG. 10A, and are therefore completely self-contained and self-explanatory. Each mode, with the exception of mode 2, can be thought of as a spatial vector, indicating a direction in which pixel values in neighboring 4×4 blocks are translated into the block being predicted.

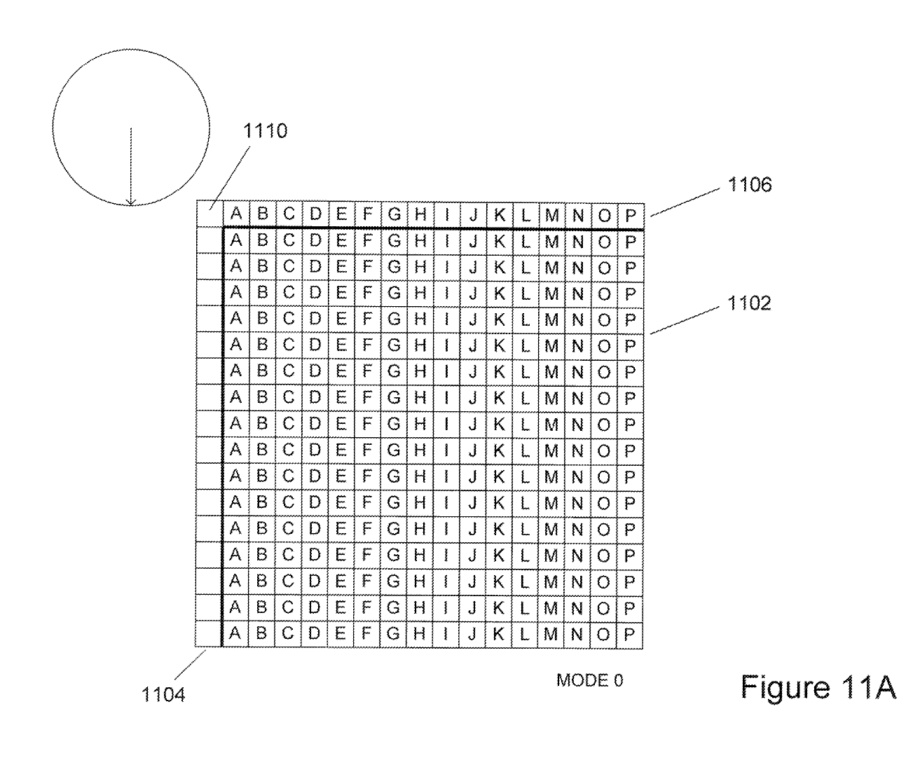

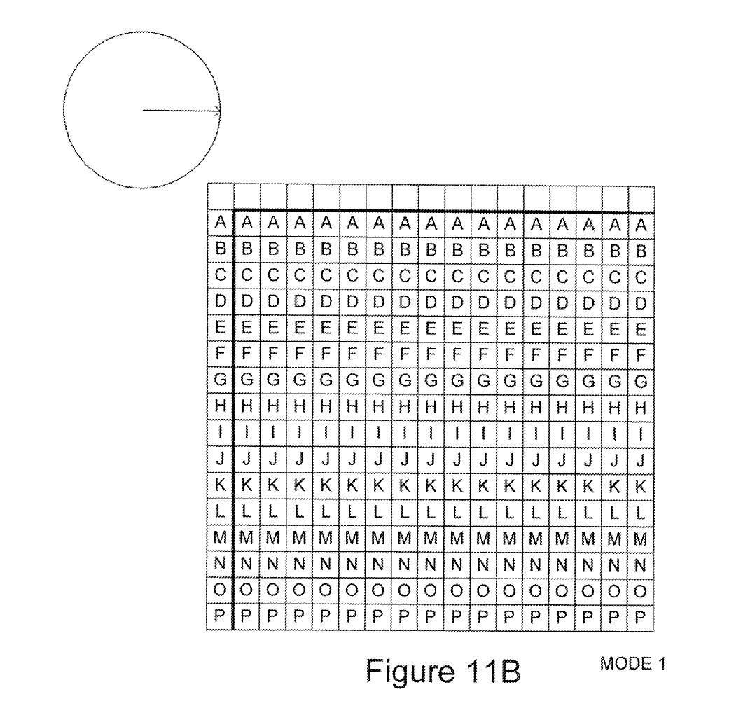

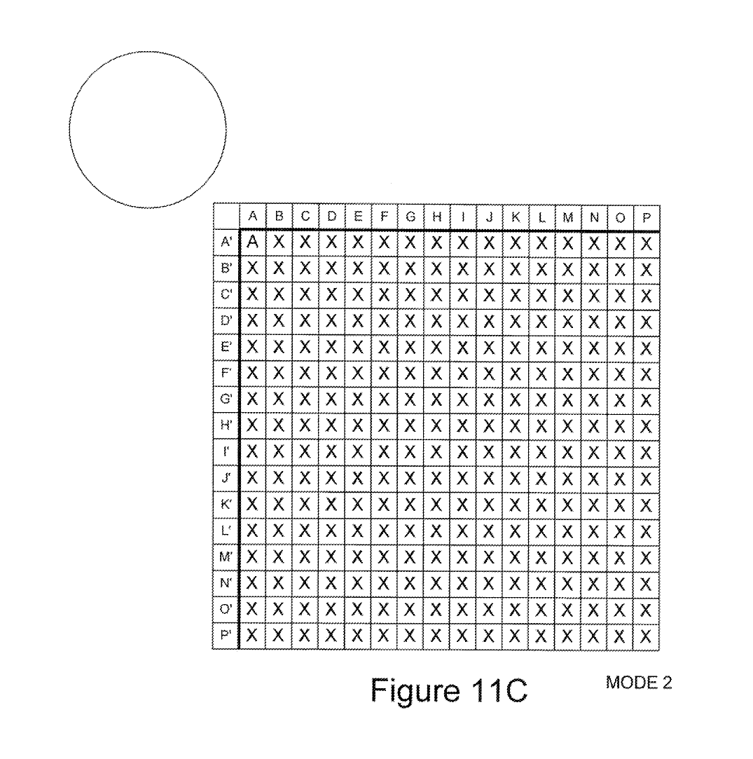

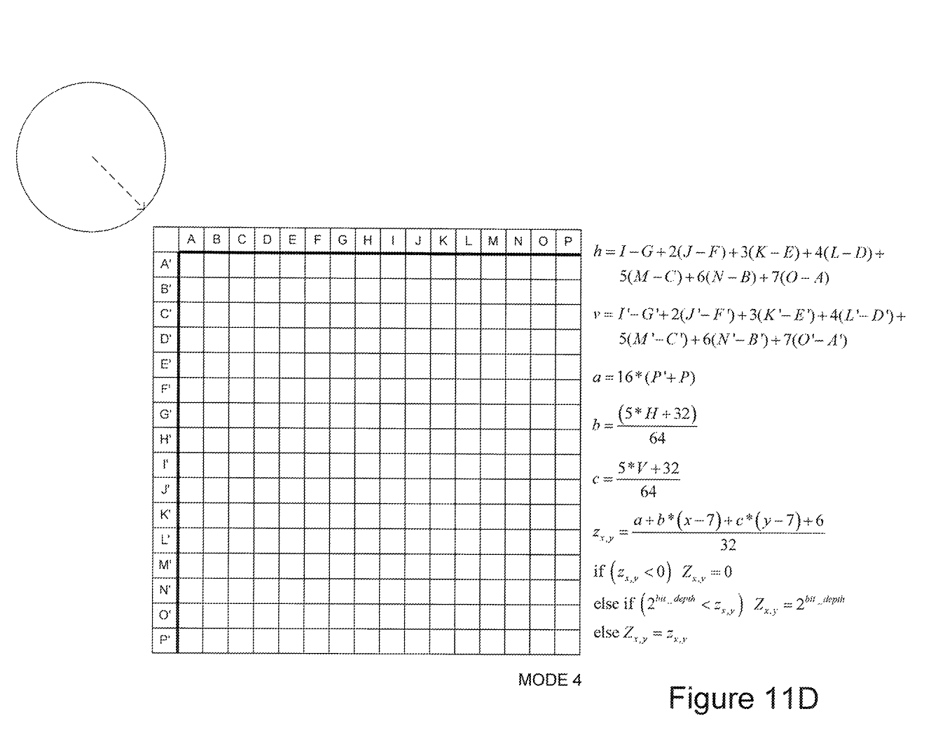

FIGS. 11A-11D illustrate, using similar illustration conventions as used in FIGS. 10A-I, the four modes for intra prediction of 16×16 luma blocks. In FIGS. 11A-D, the block being predicted is the 16×16 block in the lower right-hand portion of the matrix 1102, the leftmost vertical column 1104 is the rightmost vertical column of the left adjoining 16×16 luma block and the top horizontal row 1106 is the bottom row of the upper adjoining 16×16 luma block. The upper leftmost cell 1110 is the lower right-hand-corner cell of an upper, left diagonal 16×16 luma block. The 16×16 prediction modes are similar to a subset of the 4×4 intra prediction modes, with the exception of mode 4, shown in FIG. 11D, which is a relatively complex plane prediction mode that computes predicted values for each pixel from all of the pixels in the lower row of the upper, adjacent 16×16 luma block and the rightmost vertical column of the left adjacent 16×16 luma block. In general, the mode which produces a closest approximation to a current block that is being intra predicted is chosen as the intra-prediction mode to apply to the currently considered block. Predicted pixel values can be compared to actual; pixel values using any of various comparison metrics, including mean pixel-value differences between the predicted and considered block, the mean of squared errors in pixel values, sun of squared errors, and other such metrics.

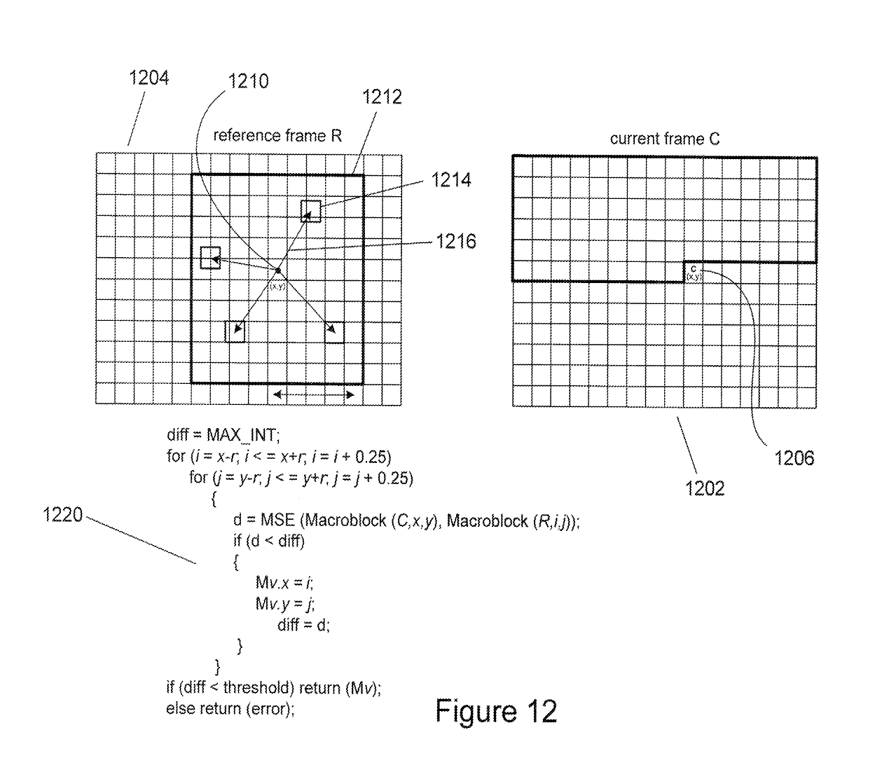

FIG. 12 illustrates the concept of inter prediction. Inter prediction, as discussed above, is temporal prediction, and can be thought of as motion-based prediction. For illustration purposes, consider a current frame 1202 and a reference frame that occurs, in the video signal, either before or after the current frame 1204. At a current point in video compression, a current macroblock 1206 needs to be predicted from the contents of the reference frame. An example of the process is illustrated in FIG. 12. In the reference frame, a reference point 1210 is chosen as the coordinates of the currently considered block 1206, with respect to the current frame, applied to the reference frame. In other words, the process begins at the equivalent position, in the reference frame, of the currently-considered block in the current frame. Then, within a bounded search space, indicated in FIG. 12 by a heavy-lined 1212 square, each block within the search area is compared to the currently considered block in the current frame in order to identify a block in the search area 1212 of the reference frame 1204 most similar to the currently considered block. If the difference between the contents of the closest block, in pixel values, within the search area to the currently considered block is below a threshold value, then the closest block selected from the search area predicts the contents of the currently considered block. The selected block from the search area may be an actual block, or may be an estimated block at fractional coordinates with respect to the rectilinear pixel grid, with pixel values in the estimated block interpolated from actual pixel values in the reference frame. Thus, using inter prediction, rather than encoding the currently considered macroblock 1206 as 256 pixel values, the currently considered macroblock 1206 can be encoded as an identifier of the reference frame and a numerical representation of the vector that points from the reference point 1210 to a macroblock selected from the search area 1212. For example, if the selected interpolated block 1214 is found to most closely match the currently considered block 1206, then the currently considered block can be encoded as an identifier for the reference frame 1204, such as an offset, in frames, within the video signal from the current frame, and a numerical representation of the vector 1216 that represents the spatial displacement of the selected block 1214 from the reference point 1210.

Various different metrics can be used to compare the contents of actual or interpolated blocks within the search area of the reference frame 1212 to the contents of the currently considered block 1206, including a mean absolute pixel-value difference or a mean squared difference between pixel values. C++-like pseudocode 1220 is provided in FIG. 12 as an alternative description of the inter-prediction process described above. An encoded displacement vector is referred to as a motion vector. The spatial displacement of the selected block from the reference point in the reference frame corresponds to a temporal displacement of the currently considered macroblock in the video stream, which often corresponds to actual motion of objects in a video image.

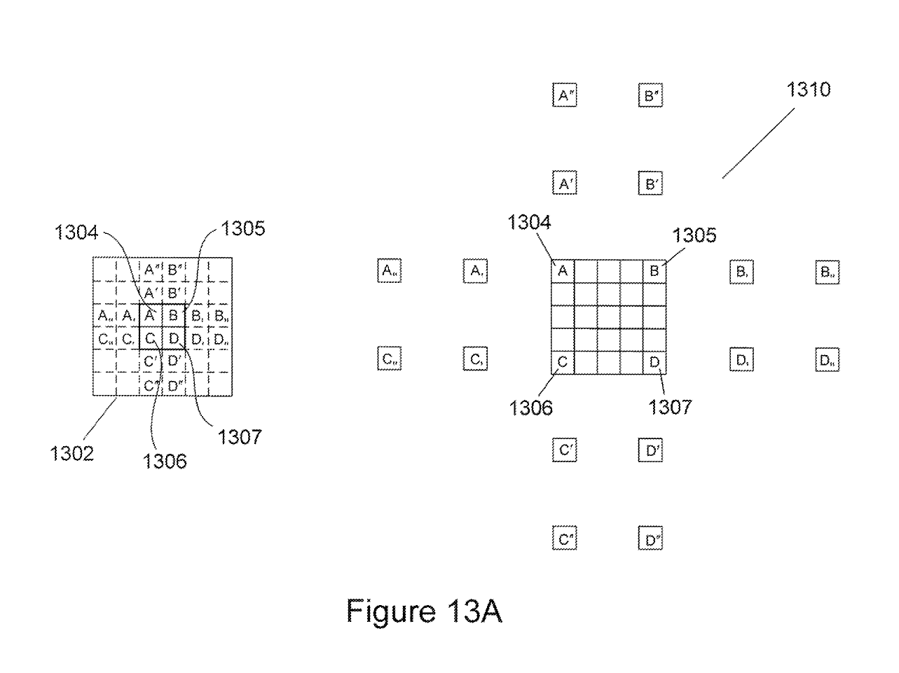

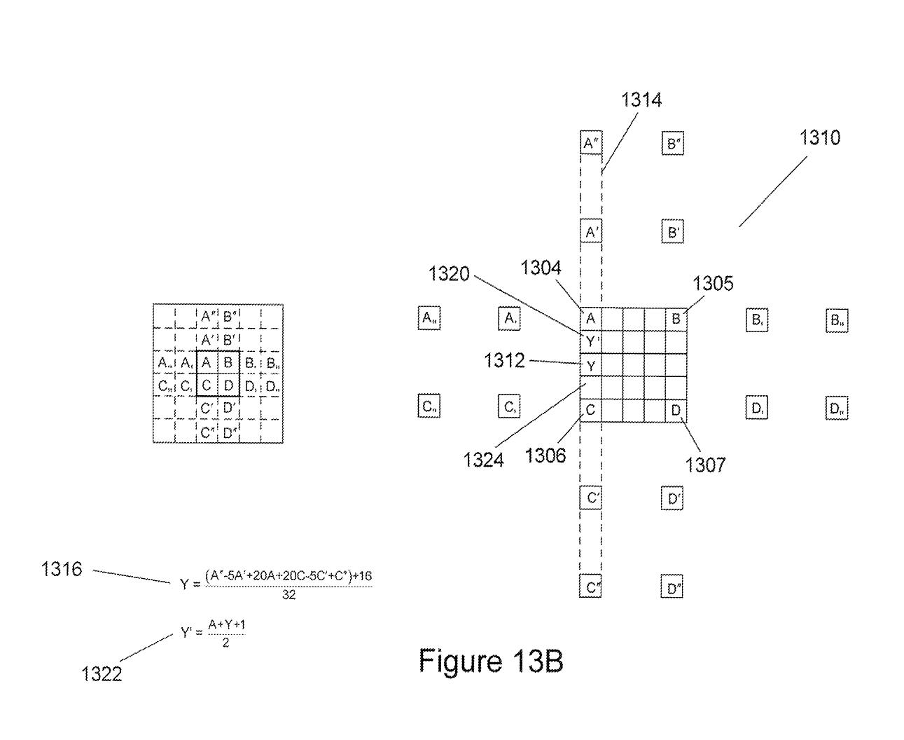

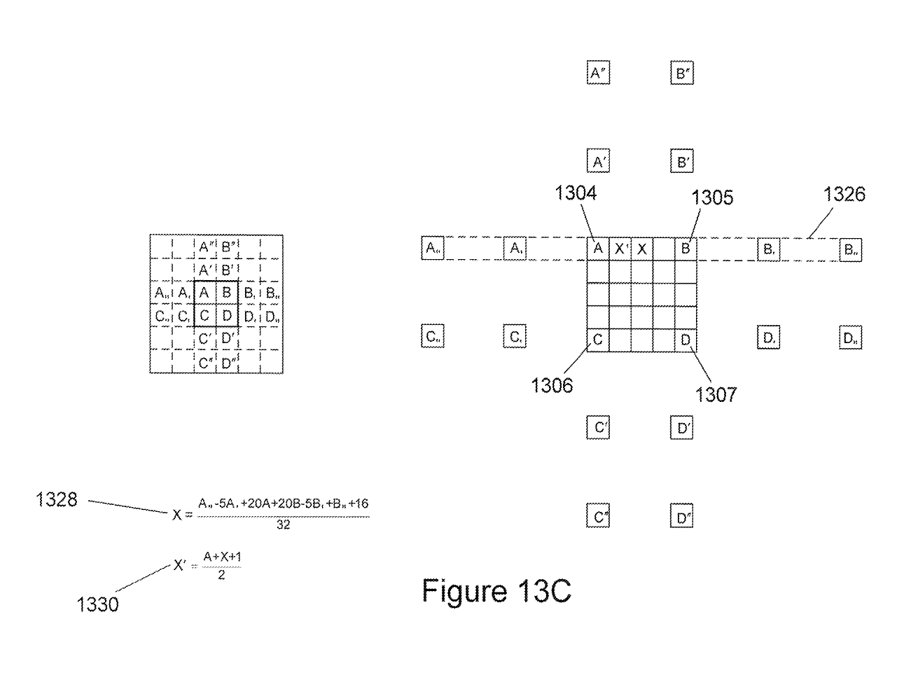

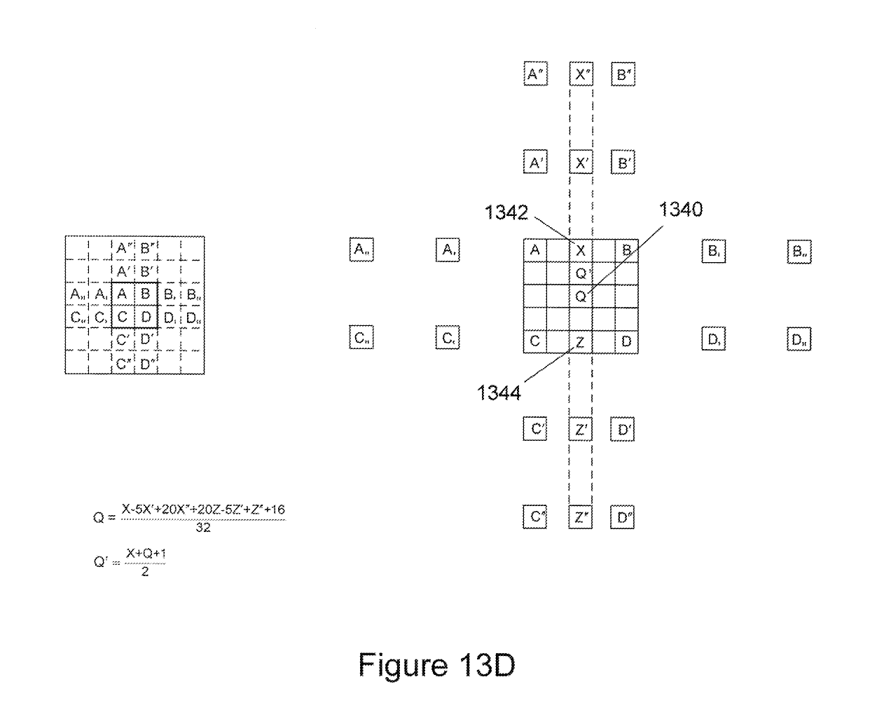

FIGS. 13A-D illustrate an interpolation process used to compute pixel values for blocks, within a search area of a reference frame, that can be thought of as occurring at fractional coordinates. The 1-1.264 standard allows for a resolution of 0.25 with respect to integer pixel coordinates. Consider the 6×6 block of pixels 1302 to the left of FIG. 13A. The interpolation process can be considered as a translational expansion of the actual pixels in two dimensions and computation of interpolated values to insert between the expanded pixels. FIGS. 13A-D illustrate computation of the higher-resolution, inserted values between the central four pixels 1304-1307 in the 6×6 block of actual pixel values. The expansion is illustrated to the right of FIG. 13A 1310. In this example, pixel values 1304-1307 have been spatially expanded, in two dimensions, and 21 new cells have been added to form a 4×4 matrix with the original pixel values 1304-1307 at the corners. The remaining pixels of the 6×6 matrix of pixels 1302 have also been translationally expanded. FIG. 13B illustrates the interpolation process to produce interpolated value 1312, midway between actual pixel values 1304 and 1306. A vertical filter is applied along the column of pixel values that include original pixel values 1304 and 1306, shown in FIG. 13B by dashed lines 1314. Interpolated value Y 1312 is computed according to formula 1316. In this example, the value Y′ 1320 is interpolated by linear interpolation of the two vertical adjacent values, according to formula 1322. The interpolation value 1324 can be similarly computed by linear interpolation between values 1312 and 1306. The vertical filter 1314 can be similarly applied to compute the interpolated values in the column containing original values 1305 and 1307. FIG. 13C illustrates computation of the interpolated values in horizontal rows between original values 1304 and 1305. In this example, a horizontal filter 1326 is applied to actual pixel values, similar to application of the vertical filter in FIG. 13B. The mid-point interpolation value is computed by formula 1328, and the quarter-point values on either side of the mid-point value can be obtained by linear interpolation according to formula 1330 and a similar formula for the right-hand interpolated value between the mid-point and original value 1305. The same horizontal filter can be applied to the final row containing original values 1306 and 1307. FIG. 13D illustrates computation of the central interpolated point 1340 and adjacent quarter-points between the interpolated mid-point values 1342 and 1344. All remaining values can be obtained by linear interpolation.

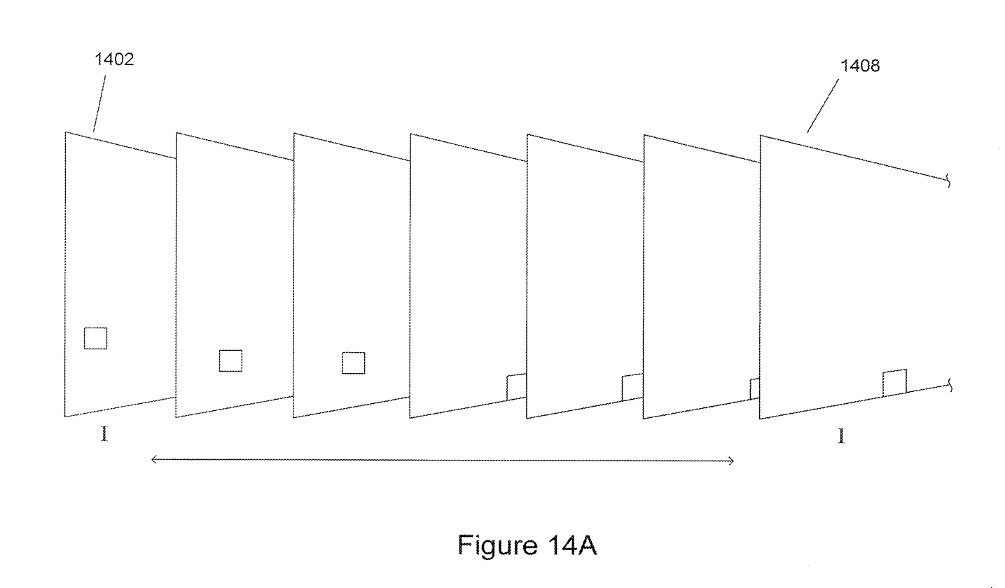

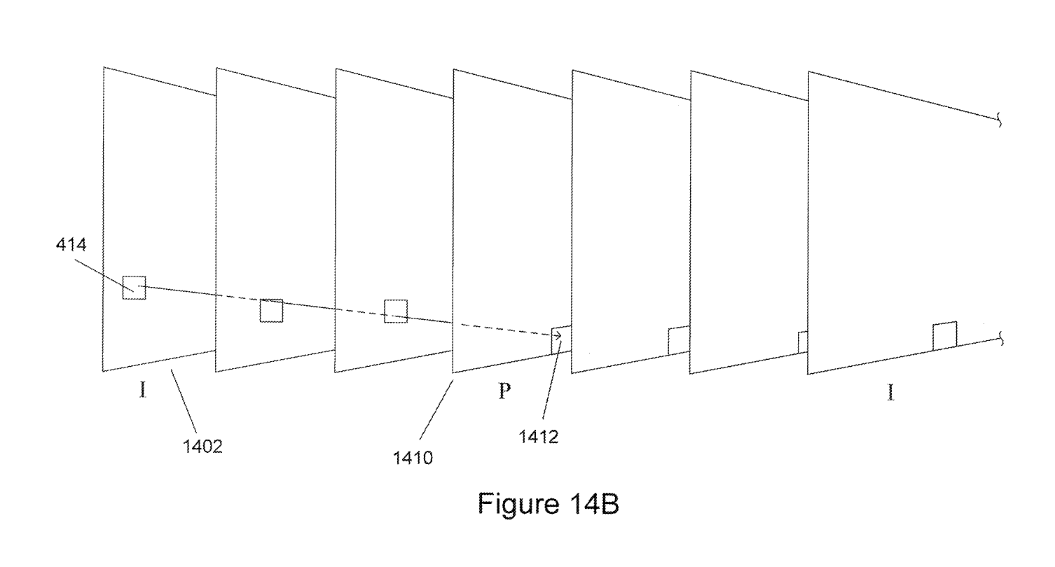

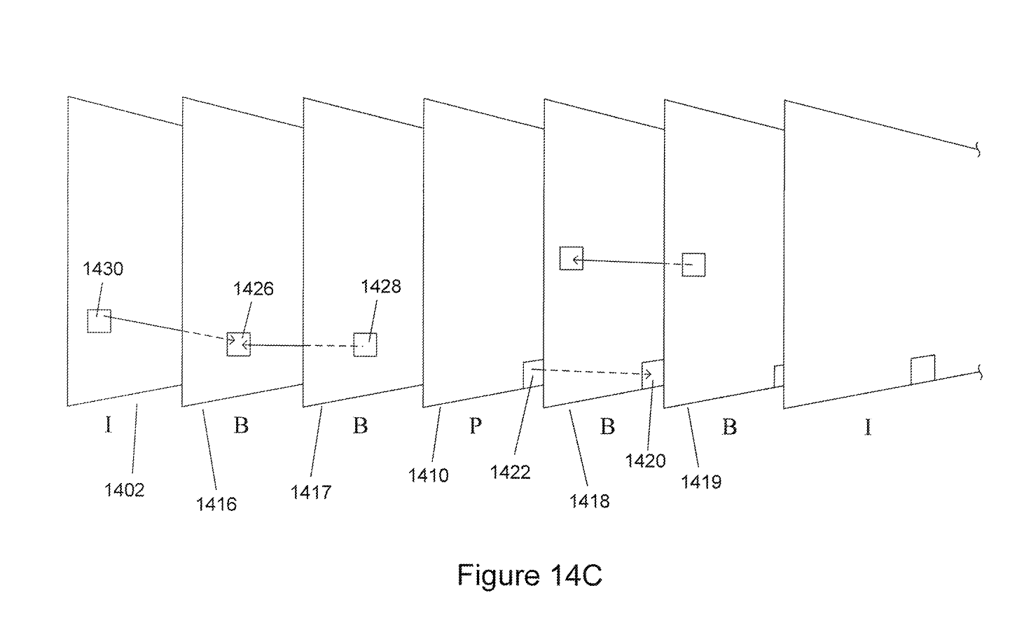

FIGS. 14A-C illustrate examples of different types of frames and the different types of inter prediction possible with respect to these different types of frames. As shown in FIG. 14A, a video signal comprises a linear sequence of video frames. In FIG. 14A, the sequence begins with frame 1402 and ends with frame 1408. A first type of frame in a video signal is referred to as an “I” frame. The pixel values of macroblocks of an I frame cannot be predicted by inter prediction. An I frame is a type of reference point within a decompressed video signal. The contents of an encoded I frame depend only on the contents of the raw-signal I frame. Thus, when systematic errors occur in decompression involving problems associated with inter prediction, the video-signal decompression can be recovered by jumping ahead to a next I reference frame and resuming decoding from that frame. Such errors do not propagate past the I-frame barriers. In FIG. 14A, the first and last frames 1402 and 1404 are I frames.

A next type of frame is illustrated in FIG. 14B. A P frame 1410 may contain blocks that have been inter predicted from an I frame. In FIG. 14B, the block 1412 has been encoded as a motion vector and an identifier for reference frame 1402. The motion vector represents temporal movement of block 1414 in reference frame 1402 to the position of block 1412 in P frame 1410. P frames represent a type of prediction-constrained frame containing blocks that may have been predicted by inter prediction from reference frames. P frames represent another type of barrier frame within an encoded video signal. FIG. 14C illustrates a third type of frame. A B frame 1416-1419 may contain blocks predicted, by inter prediction, from one or two other B frames, P frames, or I frames. In FIG. 14C, B frame 1418 contains a block 1420 that is inter predicted from block 1422 in P frame 1410. B frame 1416 contains a block 1426 that is predicted both from block 1428 in B frame 1417 and block 1430 in reference frame 1402. B frames can make best use of inter prediction, and thus achieve highest compression due to inter prediction, but also have a higher probability of various errors and anomalies that may arise in the decoding process. When a block, such as block 1426, is predicted from two other blocks, the block is encoded as two different reference-frame identifiers and motion vectors, and the predicted block is generated as a possibly weighted average of the pixel values in the two blocks from which it is predicted.

As mentioned above, were intra prediction and/or inter prediction completely accurate, extremely high compression ratios could be obtained. It is certainly far more concise to represent a block as one or two motion vectors and frame offsets than as 256 different pixel values. It is even more efficient to represent a block as one of 13 different intra-prediction modes. However, as can be appreciated by the vast number of different possible macroblock values, considering a macroblock value to be a 256-byte-encoded numerical value, neither intra nor inter prediction can possibly produce an exact prediction of the contents of blocks within a video frame, unless the video signal in which the video frame is contained contains no noise and almost no information, such as a video of a uniform, unchanging, solid-color background. However, even though intra and inter prediction cannot exactly predict the contents of macroblocks, in general, they can often relatively closely approximate the contents of macroblocks. This approximation can be used to generate difference macroblocks that represent the difference between an actual macroblock and the predicted values for the macroblock obtained by either intra or inter prediction. When the prediction is good, the resulting difference block generally contains only small or even zero pixel values.

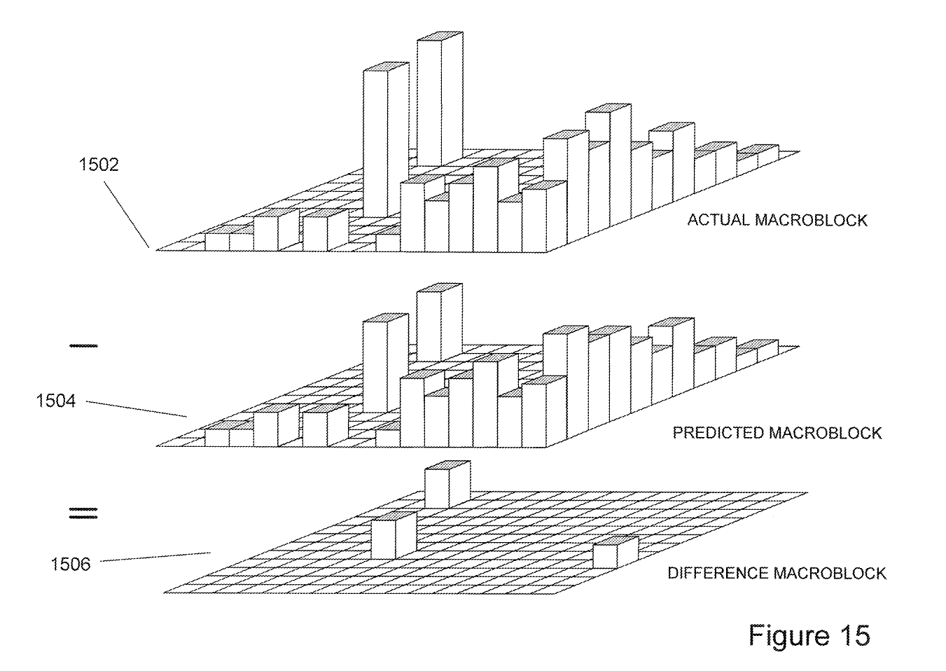

FIG. 15 illustrates examples of generation of difference macroblocks. In the FIG. 15 example, macroblocks are shown as three-dimensional graphs, in which the height of columns above a two-dimensional surface of the macroblock represent the magnitudes of pixel values within the macroblock. In FIG. 15, the actual macroblock within a currently considered frame is shown as the top three-dimensional graph 1502. The middle three-dimensional graph represents a predicted macroblock obtained by either intra or inter prediction. Note that the three-dimensional graph of the predicted macroblock 1504 is quite similar to the actual macroblock 1502. FIG. 15 represents a case where either intra or inter prediction has generated a very close approximation of the actual macroblock. Subtraction of the predicted macroblock from the actual macroblock generates a difference macroblock, shown as the lower three-dimensional graph 1506 in FIG. 15. While FIG. 15 is an exaggeration of a best case prediction, it does illustrate that the difference macroblock not only generally contains smaller-magnitude values, but often fewer non-zero values, than the actual end-predicted macroblocks. Also note that the actual macroblock can be fully restored by adding the difference macroblock to the predicted macroblock. Of course, predicted pixel values may exceed or fall below actual pixel values, so that the difference macroblock may contain both positive and negative values. However, by way of example, shifting of the origin can be used to produce an all-positive-valued difference macroblock.

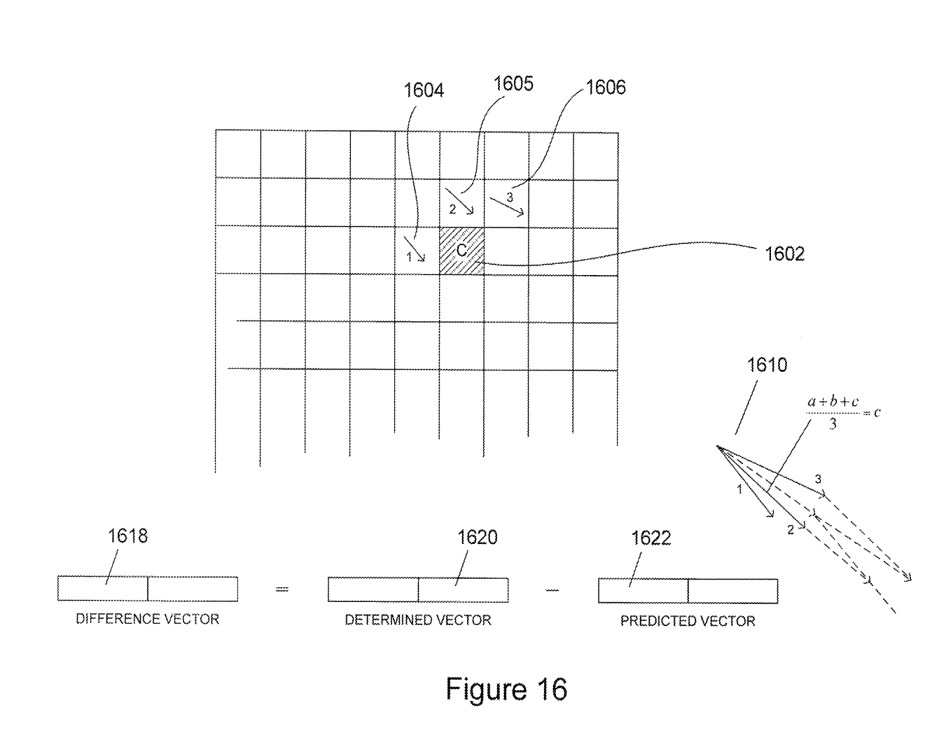

Just as the pixel values within a macroblock can be predicted from the values in blocks spatially adjacent and/or temporally adjacent to the macroblock, the motion vectors generated by inter prediction and the modes generated by intra prediction, can also be predicted. FIG. 16 illustrates an example of motion-vector and intra-prediction-mode prediction. In FIG. 16, a currently considered block 1602 is shown within a grid of blocks of a portion of a frame. Adjacent blocks 1604-1606 have already been compressed by intra or inter prediction. Therefore, there is either an intra-prediction mode, which is a type of displacement vector, or a inter-prediction motion vector associated with these neighboring, already compressed blocks. It is therefore reasonable to assume that the spatial vector or temporal vector, depending on whether intra or inter prediction is used, associated with the currently considered block 1602 would be similar to the spatial or temporal vectors associated with the neighboring, already compressed blocks 1604-1606. In fact, the spatial or temporal vector associated with currently considered block 1602 may be predicted as the average of the spatial or temporal vectors of the neighboring blocks, as shown by the vector addition 1610 to the right of FIG. 16. Therefore, rather than coding motion vectors or inter-prediction modes directly, the H.264 standard computes a difference vector, based on vector prediction, as the predicted vector 1622 subtracted from the actual computed vector 1622. The temporal motion of blocks between frames and spatial homogeneities within a frame would be expected to be generally correlated, and, therefore, predicted vectors would be expected to closely approximate actual, computed vectors. The difference vector is therefore generally of smaller magnitude than the actual, computed vector, and therefore can be encoded using fewer bits. Again, as with a difference macroblock, the actual, computed vector can be accurately reconstituted by adding the difference vector to the predicted vector.

Once a difference macroblock is produced, by either inter or intra prediction, the difference macroblock is then decomposed into 4×4 difference blocks, according to a predetermined order, each of which is transformed by an integer transform to produce a corresponding coefficient block, the coefficients of which are then quantized to produce a final sequence of quantized coefficients. The advantage of intra and inter prediction is that the transform of the difference block generally produces a large number of trailing zero coefficients, which can be quite efficiently compressed by a subsequent entropy-coding step.

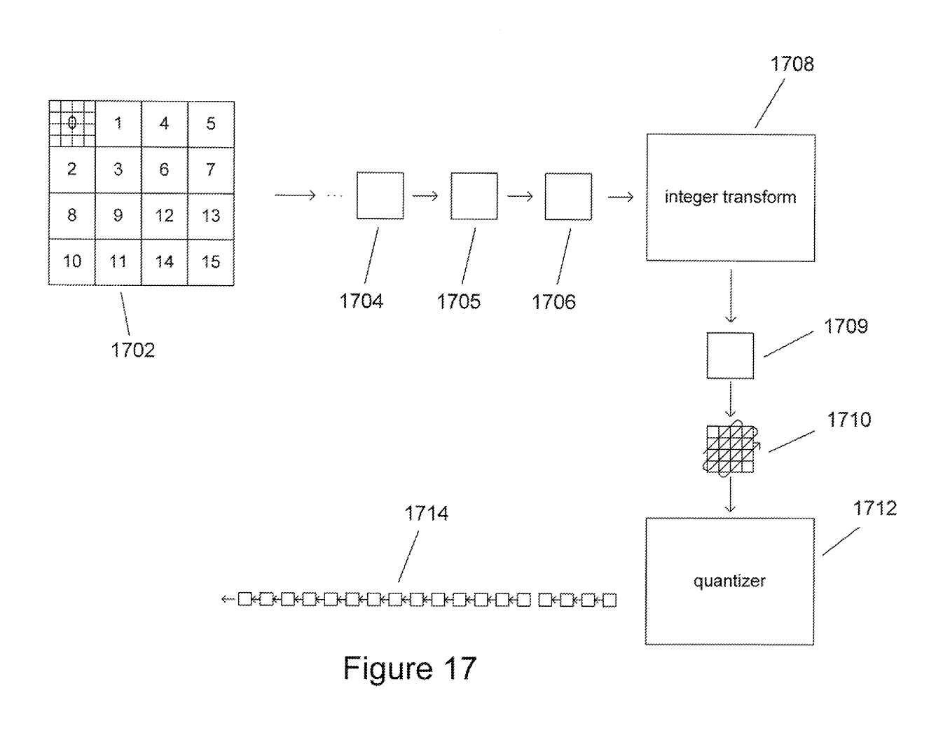

FIG. 17 illustrates one example of decomposition, integer transformation, and quantization of a difference macroblock. In this example, the difference macroblock 1702 is decomposed into 4×4 difference blocks 1704-1706 in the order described by the numerical labels of the cells of the difference macroblock in FIG. 17. An integer transform 1708 computation is performed on each 4×4 difference block to produce a corresponding 4×4 coefficient block 1708. The coefficients in the transformed 4×4 block are serialized according to a zig-zag serialization pattern 1710 to produce a linear sequence of coefficients which are then quantized by a quantization computation 1712 to produce a sequence 1714 of quantized coefficients. Many of the already discussed steps in video-signal compression are lossless. Macroblocks can be losslessly regenerated from intra or inter prediction methods and corresponding difference macroblocks. There is also an exact inverse of the integer transform. However, the quantization step 1712 is a form of lossy compression in that, once quantized, an approximate value of the original coefficient can be regenerated by an approximate inverse of the quantization method, referred to as “resealing.” Chroma-plane decimation is another lossy compression step, in that the higher-resolution chroma data cannot be recovered from lower-resolution chroma data. Quantization and chroma-plane decimation are, in fact, the two lossy compression steps in the H.264 video-compression technique.

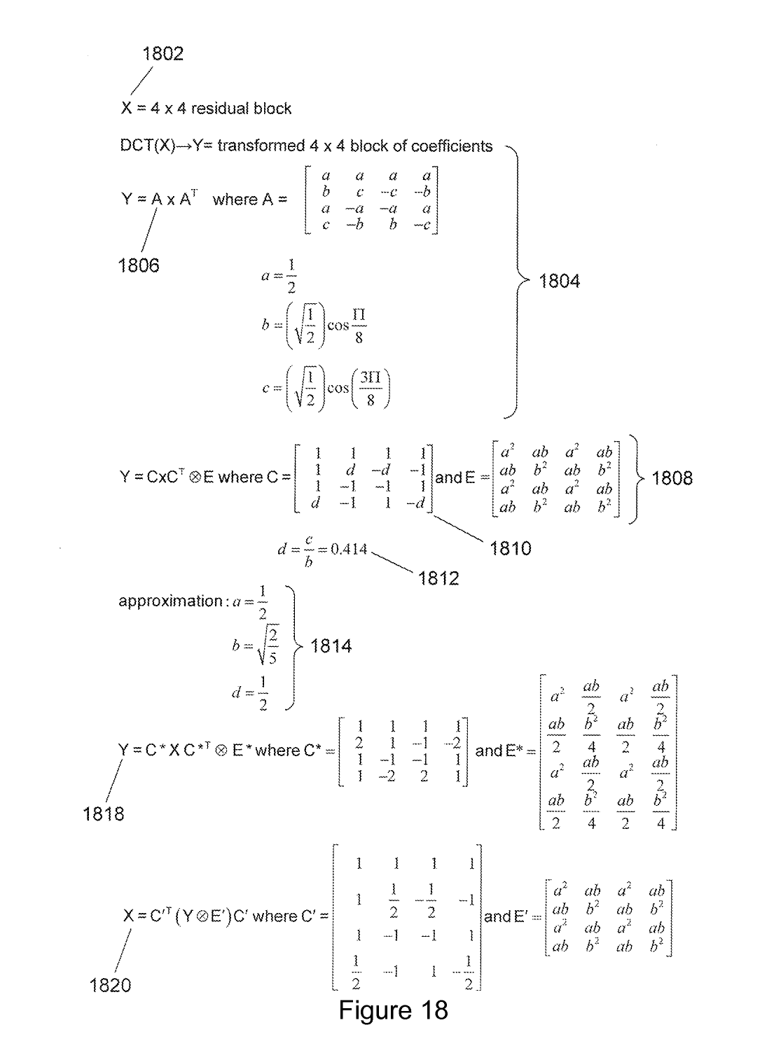

FIG. 18 provides derivation of the integer transform and inverse integer transform employed in H.264 video compression and video decompression, respectively. The symbol “X” 1802 represents a 4×4 difference, or residual, block (e.g. 1704-1706 in FIG. 17). A discrete cosine transform, a well-known discrete-Fourier-like transform, is defined by a first set of expressions 1804 in FIG. 18. The discrete cosign transform is, as shown expression 1806, a matrix-multiplication-based operation. The discrete cosign transform can be factored as shown in expression 1808 in FIG. 18. The elements of matrix C 1810 include a rational number “d” 1812. In order to efficiently approximate the discrete cosign transform, this number can be approximated as ½, leading to approximate matrix elements 1814 in FIG. 18. This approximation, with multiplication of two rows of matrix C in order to produce all-integer elements, produces the integer transform 1818 in FIG. 18 and a corresponding inverse integer transform 1820.

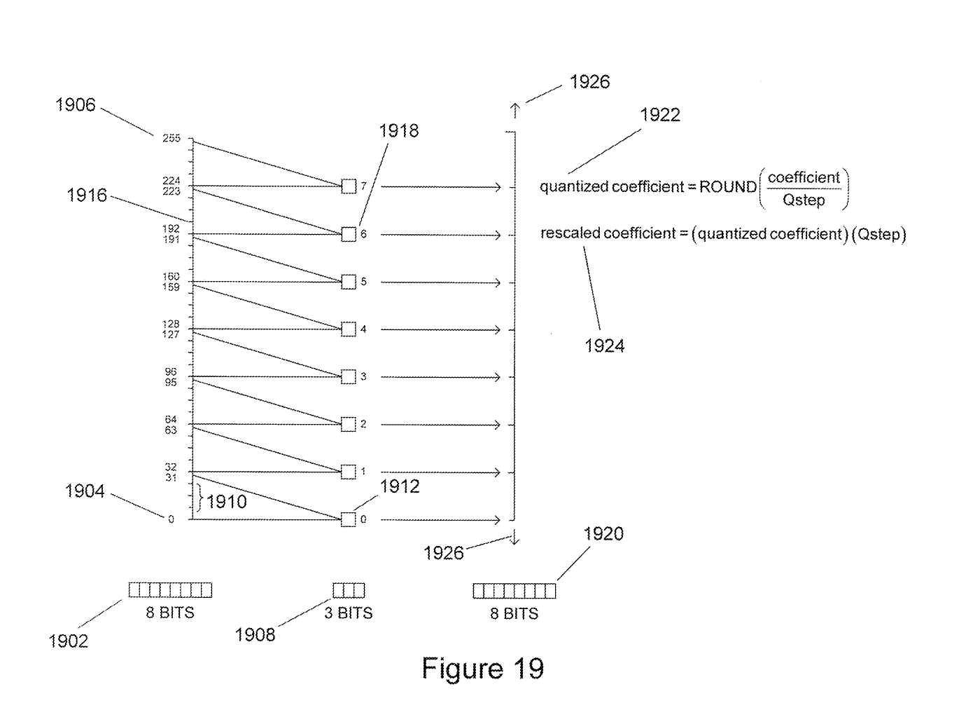

FIG. 19 illustrates the quantization process. Consider, as a simple example, a number encoded in eight bits 1902 that can therefore range in value between 0 (1904 in FIG. 19) and 255 (1906 in FIG. 19), potentially assuming any integer value in the range 0-255. A quantization process can be used to encode the eight-bit number 1902 in only three bits 1908 by an inverse linear interpolation of integers in the range 0-255 to integers in the range 0-7, as shown in FIG. 19. In this case, integer values 0-31 represented by an eight-bit-encoded number are all mapped to the value 0 (1912 in FIG. 19). Successive ranges of 32 integer values are mapped to the values 1-7. Thus, for example, quantization of the integer 200 (1916 in FIG. 19) produces the quantized value 6 (1918 in FIG. 19). Eight-bit values can be regenerated from the three-bit quantized values by simple multiplication. The three-bit quantized value can be multiplied by 32 to produce an approximation of the original eight-bit number. However, the approximate number 1920 can have only one of the values 0, 32, 64, . . . , 224. In other words, quantization is a form of numeric-value decimation, or loss of precision. A resealing process, or multiplication, can be used to regenerate numbers that approximate the original values that were quantized, but cannot recover the precision lost in the quantization process. In general, quantization is expressed by formula 1922, and the inverse of quantization, or resealing, is expressed by formula 1924. The value “Qstep” in these formulas controls the degree of precision lost in the quantization procedure. In the example illustrated on the left side of FIG. 19, Qstep has the value “32.” A smaller value of Qstep provides a smaller loss in precision, but also less compression, while larger values provide greater compression, but also greater loss of precision. For example, in the example shown in FIG. 19, had Qstep been 128 rather than 32, the eight-bit number could have been encoded in a single bit, but resealing would produce only the two values 0 and 128. Note also that the resealed values can be vertically shifted, as indicated by arrows 1926 and 1928, by an additional addition step following resealing. For example, in the example shown in FIG. 19, rather than generating values 0, 32, 64, . . . , 224, addition of 16 to the resealed values generates corresponding values of 16, 48, . . . , 240, leaving a less dramatic gap at the top of the resealed vertical number line.

Following quantization of residual, or difference, blocks and collection of difference vectors and other objects produced as a stream of data from the steps upstream to entropy encoding, an entropy encoder is applied to the partially compressed data stream to produce an entropy-encoded data stream that comprises the payload of the NAL packets, described above with reference to FIG. 5. Entropy encoding is a lossless encoding technique that takes advantage of statistical non-uniformities in the partially encoded data stream. One well-known example of entropy encoding is the Morse code, which uses single-pulse encoding of commonly occurring letters, such as “E” and “T,” and four-pulse or five-pulse encodings of infrequently encountered letters, such as “Q” and “Z.”

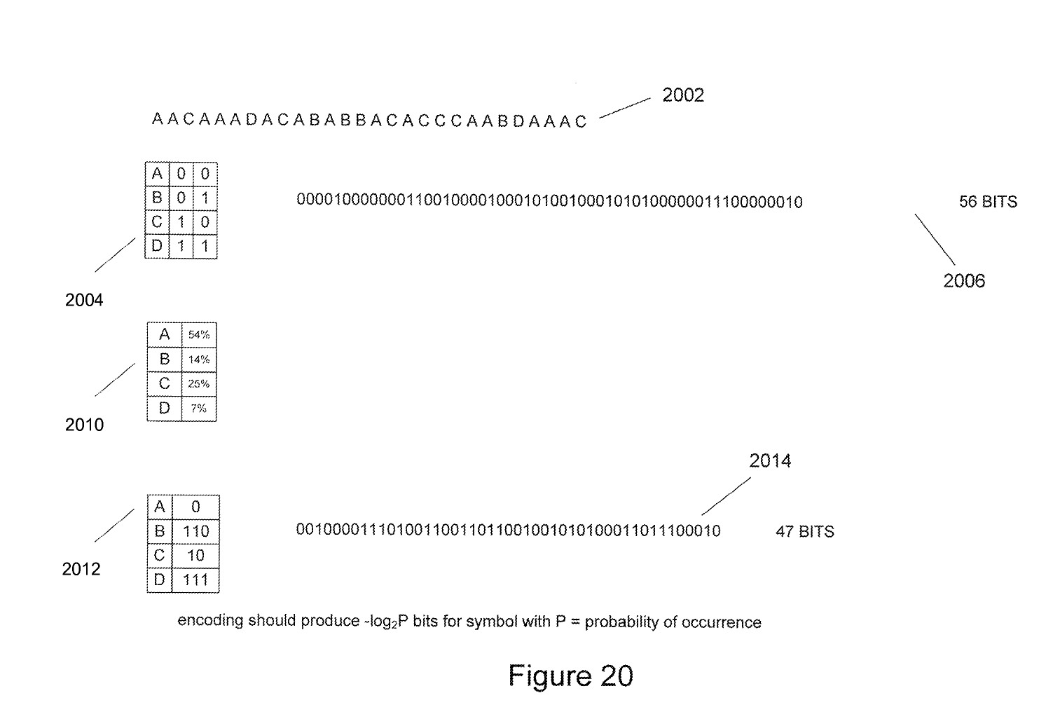

FIG. 20 provides a numerical example of entropy encoding. Consider the four-symbol character string 2002 comprising 28 symbols, each selected from one of the four letters “A,” “B,” “C,” and “D.” A simple and intuitive encoding of this 28-symbol string would be to assign one of four different two-bit codes to each of the four letters, as shown in the encoding table 2004. Using this two-bit encoding, a 56-bit encoded symbol string 2006 equivalent to symbol string 2002 is produced. However, analysis of the symbol string 2002 reveals the percentage occurrence of each symbol, shown in table 2010. “A” is, by far, the most frequently occurring symbol, and “D” is, by far, the least frequently occurring symbol. A better encoding is represented by encoding table 2012, which uses a variable-length representation of each symbol. “A” being the most frequently occurring symbol, is assigned the code “0.” The least-frequently occurring symbols “B” and “D” are assigned the codes “110” and “111,” respectively. Using this encoding produces the encoded symbol string 2014, which uses only 47 bits. In general, a binary entropy encoding should produce an encoded symbol of −log₂P bits for symbols with a probability of occurrence of P. While the improvement in encoding length is not spectacular, in the example shown in FIG. 20, for long sequences of symbols having decidedly non-uniform symbol-occurrence distributions, entropy encoding produces relatively high compression ratios.

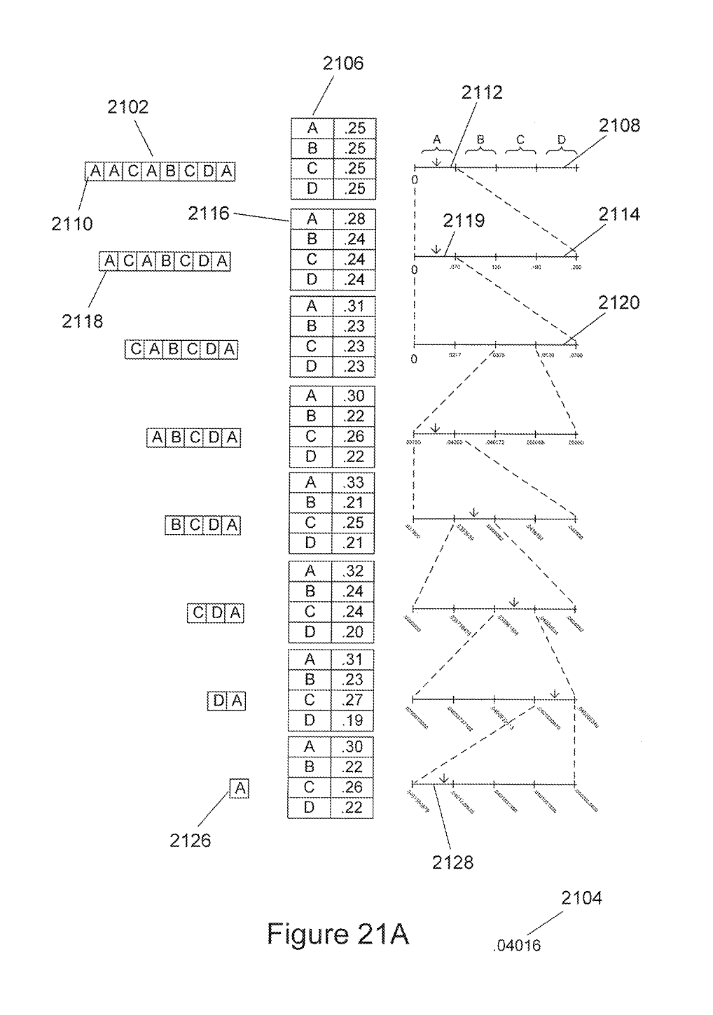

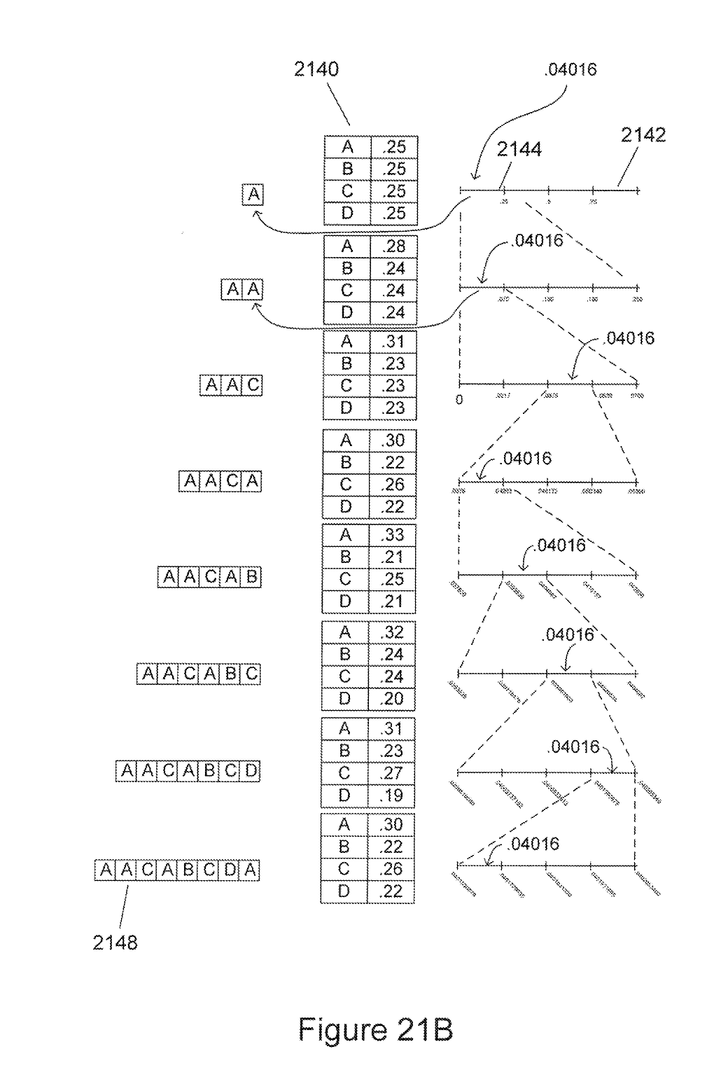

One type of entropy encoding is referred to as “arithmetic encoding.” A simple example is provided in FIGS. 21A-B. The arithmetic encoding illustrated in FIGS. 21A-B is a version of a context-adaptive encoding method. In this example, an eight-symbol sequence 2102 is encoded as a five-place fractional value 0.04016 (2104 in FIG. 21A), which can be encoded by any of various known binary numerical encodings to produce a binary encoded symbol string. In this simple example, a symbol-occurrence-probability table 2106 is updated constantly during the coding process. This provides context adaption, since the encoding method dynamically changes, over time, as the symbol-occurrence probabilities are adjusted according to the symbol-occurrence frequencies observed during coding. Initially, for lack of a better set of initial probabilities, the probabilities for all symbols is set to 0.25. At each step, an interval is employed. The interval at each step is represented by a number line, such as number line 2108. Initially, the interval ranges from 0 to 1. At each step, the interval is divided into four partitions according to the probabilities in the current symbol-occurrence-frequency table. Because the initial table contains equal probabilities of 0.25, the interval is divided, in the first step, into four equal parts. In the first step, the first symbol “A” 2110 in the symbol sequence 2102 is encoded. The interval partition 2112 corresponding to this first symbol is selected as the interval 2114 for the next step. Furthermore, because the symbol “A” was encountered, the symbol-occurrence probabilities are adjusted in the next version of the table 2116 by increasing probability of occurrence for symbol “A” by 0.03, and decreasing probabilities of occurrence of the remaining symbols by 0.01. The next symbol is also “A” 2118, and so the first interval partition 2119 is again selected, to be the subsequent interval 2120 for the third step. This process continues until all symbols in the symbol string have been consumed. The final symbol, “A,” 2126, selects the first interval 2128 in the final interval computed in the procedure. Note that the intervals decrease in size with each step, and generally require a greater number of decimal places to specify. The symbol string can be encoded by selecting any value within the final interval 2128. The value 0.04016 falls within this interval, and therefore represents an encoding of the symbol string. The original symbol string can be regenerated, as shown in FIG. 21B, by starting the process again with an initial, equal-valued symbol-occurrence-frequency probability table 2140 and an initial interval of 0-1 2142. The encoding, 0.04016, is used to select a first partition 2144 which corresponds to the symbol “A.” Then, in steps similar to the steps in the forward process, shown in FIG. 21A, the encoding 0.04016 is used to select each subsequent partition of each subsequent interval until the final symbol string is regenerated 2148.

While this example illustrates the general concept of arithmetic encoding, it is an artificial example, because the example assumes infinite precision arithmetic and because the symbol-occurrence-frequency-probability table adjustment algorithm would quickly lead to unworkable values. Actual arithmetic encoding does not assume infinite precision arithmetic, and instead employs techniques to adjust the intervals in order to allow for interval specification and selection within the precision provided by any particular computer system. The H.264 standard specifies several different encoding schemes, one of which is a context-adaptive arithmetic encoding scheme. Table-lookup procedures are used for encoding frequently occurring symbol strings produced by the up-stream encoding techniques, including various metadata and parameters included in the partially compressed data stream to facilitate subsequent decompression.

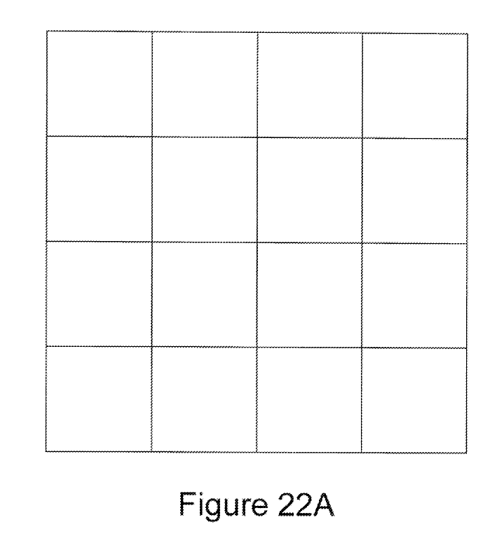

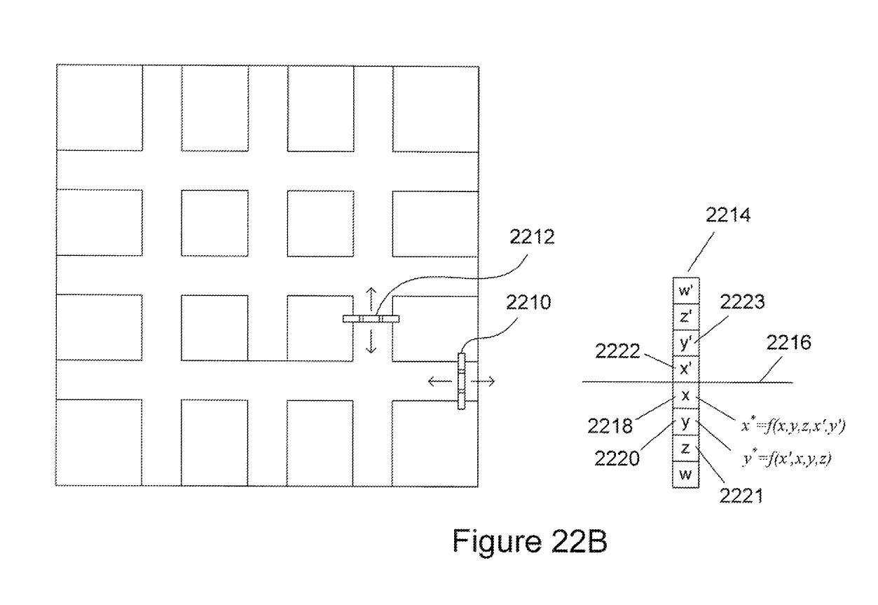

When video-data streams are compressed according to the H.264 technique, subsequent decompression may yield certain types of artifacts. By way of example, FIGS. 22A-B illustrate one commonly occurring artifact and a filtering method that is used, as a final step in decompression, to ameliorate the artifact. As shown in FIG. 22A, a decompressed video image, without filtering, may appear blocked. Because decompression and compression are carried out on a block-by-block basis, various block boundaries can represent significant discontinuities in compression/decompression processing, leading to a visually-perceptible blocking of a displayed, decompressed video image. FIG. 22B illustrates a deblocking-filter method, employed in H.264 decompression, to ameliorate the blocking artifact. In this technique, vertical 2210 and horizontal 2212 filters, similar to the filters used for pixel-value interpolation, discussed above with reference to FIGS. 13A-D, are passed along all block boundaries in order to smooth discontinuities in the pixel-value gradients across the block boundaries. Three pixel values on each side of the boundary may be affected by the block-filter method. On the right of FIG. 22B, an example of a deblocking-filter application is shown. In this example, the filter 2214 is represented as a vertical column containing four pixel values on either side of a block boundary 2216. Application of the filter produces filtered pixel values for the first three pixel values on either side of the block boundary. As one example, the filtered value for pixel 2218, x*, is computed from the prefiltered values of pixels 2218, 2220, 2221, 2222, and 2223. The filter tends to average, or smear, pixel values in order to reestablish a continuous gradient across the boundary.

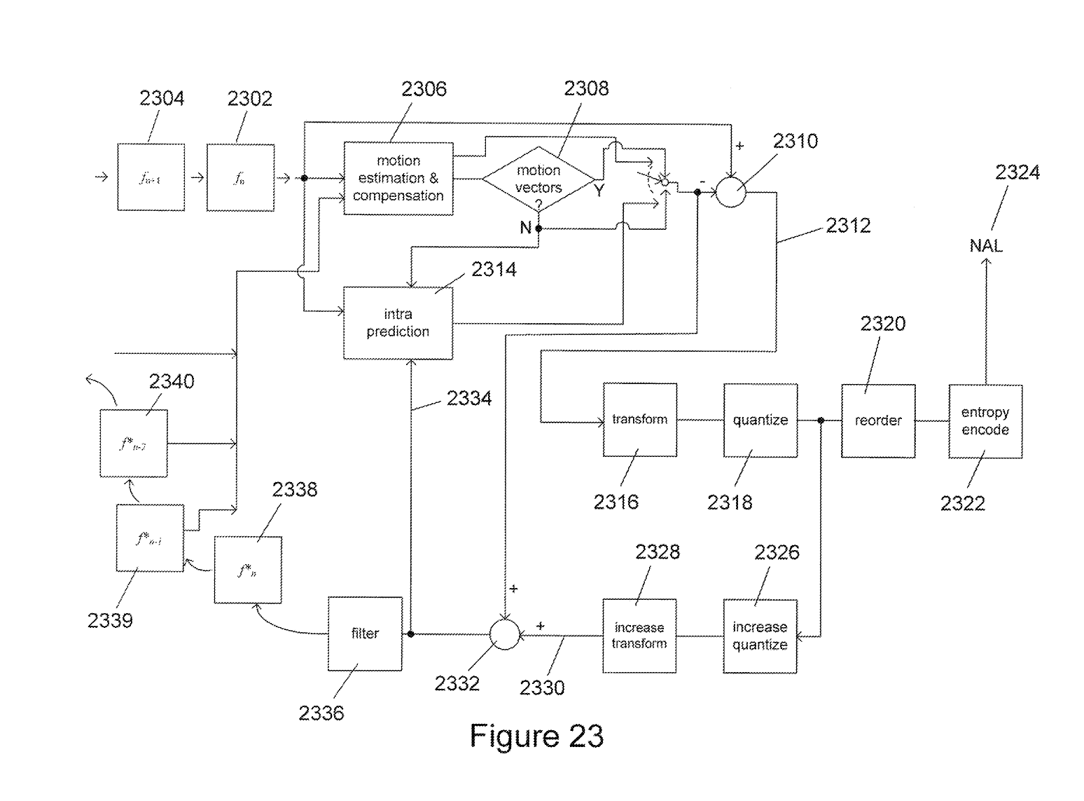

FIG. 23 summarizes H.264 video-data-stream encoding. FIG. 23 provides a block diagram, and a therefore high-level description of the encoding process. However, this diagram, along with the previous discussion and previously referenced figures, provides a substantial overview of H.264 encoding. Additional details are revealed, as necessary, to describe particular video-codec embodiments of the present invention. It should be noted that there are a plethora of fine points, details, and special cases in video encoding and video decoding that cannot be addressed in an overview section of this document. For case of communication and simplification, the examples herein are largely based on the H.264 standard, however, in no way should it be construed that the invention presented herein is limited to H.264 applications. The official H.264 specification is over 500 pages long. These many details include, for example, special cases that arise from various boundary conditions, specific details, and optional alternative methods that can be applied in various context-related cases. Consider, for example, intra prediction. Intra prediction modes depend on the availability of pixel values in specific, neighboring blocks. For boundary blocks without neighbors, many of the modes cannot be used. In certain cases, unavailable neighboring pixel values may be interpolated or approximated in order to allow a particular intra-prediction mode to be used. Many interesting details in the encoding process are related to choosing optimal prediction methods, quantization parameters, and making other such parameter choices in order to optimize the compression of a video data stream. The H.264 standard does not specify how compression is to be carried out, but instead specifies the format and contents of an encoded video-data stream and how the encoded video data stream is to be decompressed. The H.264 standard also provides a variety of different levels of differing computational complexity, with high-end levels supporting more computationally expensive, but more efficient additional steps and methods. The current overview is intended to provide sufficient background to understand the subsequently provided description of various embodiments of the present invention, but is in no way intended to constitute a complete description of H.264 video encoding and decoding.

In FIG. 23, a stream of frames 2302-2304 are provided as input to an encoding method. In this example, the frames are decomposed into macroblocks or macroblock partitions, as discussed above, for subsequent processing. In a first processing step, a currently considered macroblock or macroblock partition is attempted to be inter predicted from one or more reference frames. When inter prediction is successful, and one or more motion vectors generated, as determined in step 2308, then the predicted macroblock generated by the motion estimation and compensation step 2306 is subtracted from the actual, raw macroblock in a differencing step 2310 to produce a corresponding residual macroblock which is output by the differencing step onto data path 2312. However, if inter prediction fails, as also determined in step 2308, then an intra prediction step 2314 is launched to carry out intra prediction on the macroblock or macroblock partition, which is then subtracted from the actual raw macroblock or macroblock partition, in step 2310, to produce a residual macroblock or residual macroblock partition output to data path 2312. The residual macroblock or residual macroblock partition is then transformed, by the transform step 2316, quantized by the quantize step 2318, potentially reordered for more efficient encoding in step 2320, and then entropy encoded in step 2322 to produce a stream of output NAL packets 2324. In general, compression implementations seek to employ the prediction method that provides closest prediction of a considered macroblock, while balancing the cost, in time and memory usage, of various prediction methods. Any of various different orderings and selection criteria for applying prediction methods can be used.

Continuing to follow the example of FIG. 23, following quantization, in step 2318, the quantized coefficients are input to the re-ordering and entropy-encoding stages 2320 and 2322, and also input to an inverse quantizer 2326 and an inverse transform step 2328 to regenerate a residual macroblock or residual macroblock partition that is output onto data path 2330 by the inverse transform step. The residual macroblock or macroblock partition output by the inverse transform step is generally not identical to the residual macroblock or residual macroblock partition output by the differencing step 2310 to data path 2312. Recall that quantization is a lossy compression technique. Therefore, the inverse quantizing step 2326 produces an approximation of the original transform coefficients, rather than accurately reproducing the original transform coefficients. Therefore, although the inverse integer transform would produce an exact copy of the residual macroblock or macroblock partition, were it applied to the original coefficients produced by the integer transform step 2316, because the inverse integer transform step 2328 is applied to resealed coefficients, only an approximation to the original residual macroblock or macroblock partition is produced in step 2328. The approximate residual macroblock or macroblock partition is then added to the corresponding predicted macroblock or macroblock partition, in the addition step 2332, to generate a decompressed version of the macroblock. The decompressed, but not filtered, version of the macroblock is input to the intra prediction step 2312, via data path 2334, for intra prediction of a subsequently processed block. The deblocking filter 2336 step is performed on decompressed macroblocks to produce filtered, decompressed macroblocks that are then combined to produce decompressed images 2338-2340 that may be input to the motion estimation and compensation step 2306. One subtlety involves input of the decompressed frames to motion estimation and compensation step 2306 and decompression, but non-filtered macroblocks and macroblock partitions to the intra prediction step 2314. Recall that both intra prediction and most motion estimation and compensation use neighboring blocks, either in a current frame, in the case of spatial prediction, or in previous and/or subsequent frames, in the case of temporal, inter prediction, in order to predict values in a currently considered macroblock or macroblock partition. But, consider the recipient of a compressed data stream. The recipient will not have access to the original, raw video frames 2302 and 2304. Therefore, during decompression, the recipient of the encoded video data stream will use previously decoded or decompressed macroblocks for predicting the contents of subsequently decoded macroblocks. If the encoding process were to use the raw video frames for prediction, then the encoder would be using different data for prediction than is subsequently available to the decoder. This would cause significant errors and artifacts in the decoding process. To prevent this, the encoding process generates decompressed macroblocks and macroblock partitions, and decompressed and filtered video frames for use in the inter and intra prediction steps, so that intra and inter prediction use the same data for predicting contents of macroblocks and macroblock partitions as will be available to any decompressing procedure that can rely only on the encoded video data stream for decompression. Thus, the decompressed but unfiltered macroblock and macroblock partitions input through data path 2334 to the intra prediction step 2314 are the neighboring blocks from which a current macroblock or macroblock partition is subsequently predicted, and the decompressed and filtered video frames 2338-2340 are used as reference frames by the motion estimation and compensation step 2306 for processing other frames.

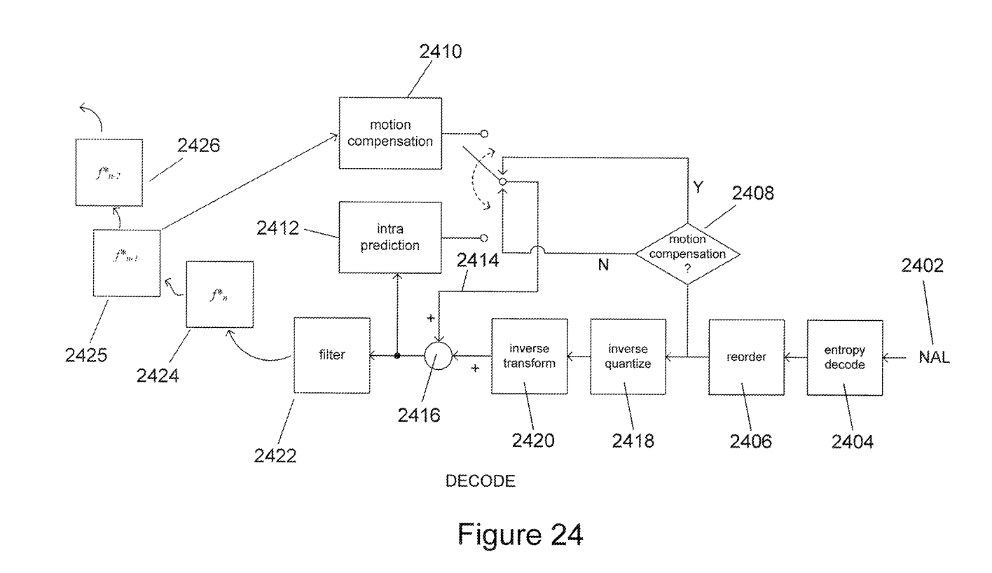

FIG. 24 illustrates an example in a block diagram fashion similar to that used in FIG. 23, the H.264 video-data-stream decoding process. Decompression is more straightforward than compression. A NAL packet stream 2402 is input into an entropy decode step 2404 which applies an inverse entropy encoding to generate quantized coefficients that are reordered by a reordering step 2406 complementary to the reordering carried out by the reorder step 2320 in FIG. 23. Information in the entropy decoded stream can be used to determine the parameters by which the data was originally encoded, including whether or not intra prediction or inter prediction was employed during compression of each block. This data allows for selecting, via step 2408, either inter prediction, in step 2410, or intra prediction, in step 2412, for producing predicted values for macroblocks and macroblock partitions that are furnished along data path 2414 to an addition step 2416. The reordered coefficients are resealed by an inverse quantifier, in step 2418, and an inverse integer transform is applied, in step 2420, to produce an approximation of the residual, or residual, macroblocks or macroblock partitions, which are added, in the addition step 2416, to predicted macroblocks or macroblock partitions generated based on previously decompressed macroblocks or macroblock partitions. The addition step produces decompressed macroblocks or macroblock partitions to which a deblocking filter is applied in order to produce final decompressed video frames, in step 2422, to produce the decompressed video frames 2424-2426. The decompression process is essentially equivalent to the lower portion of the compression process, shown in FIG. 23.

### Subsection II

### Principles of Parallel Integrated-Circuit Design for Addressing Complex Computational Tasks in Video Acquisition and Processing Systems According to the Present Invention

In this subsection, the principles for developing parallel, pipelined, integrated-circuit video acquisition and processing systems that carry out in real time H.264 compression and decompression are described as an example of the general approach of video acquisition and video codec design that represent embodiments of the present invention. The video acquisition and processing systems of the present invention are in no way limited to H.264 implementations.

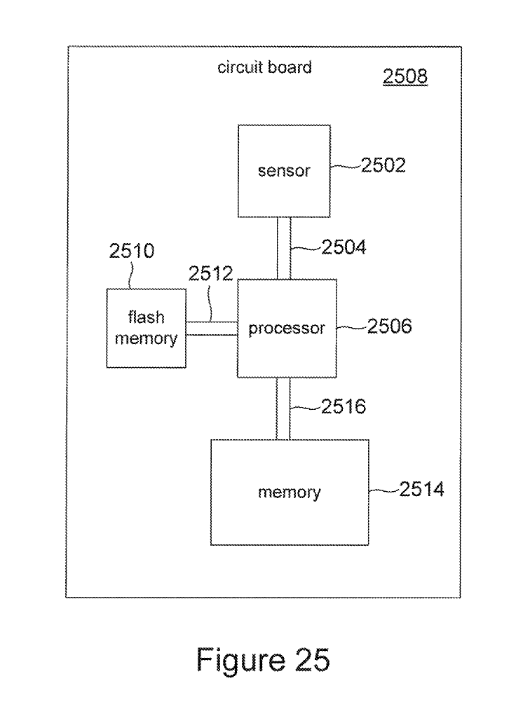

FIG. 25 illustrates a very high-level diagram of a sensor 2502 electronically connected via a bus 2504 to a processor 2506 on a circuit board 2508 of a typical video camera. In the example of FIG. 25, the processor 2506 is electronically connected to a flash memory 2510 via a bus 2512 and a SDRAM, DDR, or DDR2 memory 2514 via a bus 2516. The flash memory 2510 stores image signal processing instructions that are fetched by the processor 2506 in processing raw video signals produced by the sensor 2502 into a suitable color model and format for image display, such as YCrCb (4:2:2) or YCrCb (4:2:0). The image data is stored during image processing in the memory 2514. Once an image has been captured and the corresponding raw video signals sent to the processor and memory, a large percentage of the image signal processing is devoted to transferring image data and program instructions between the processor, memory, and flash memory. A conventional circuit board implementation may require from about 400 to more than 600 pins to interconnect the sensor, processor, memory, flash memory and other devices of the circuit board. After the raw image data has been processed by the camera into a suitable image data format, the image data can be sent to a video codec for compression and decompression.

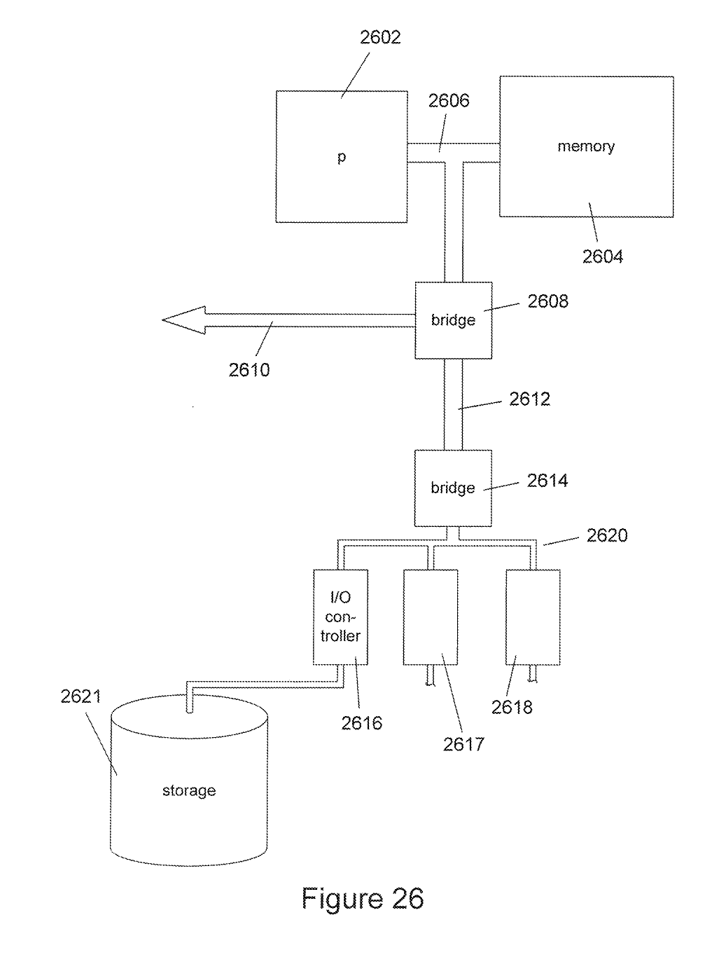

One way to implement a video codec that carries out the H.264 video compression and decompression, discussed in the first subsection, is to program the encoding and decoding processes in software, and execute the program on a general-purpose computer. FIG. 26 is a very high-level diagram of a general-purpose computer. The computer includes a processor 2602, memory 2604, a memory/processor bus 2606 that interconnects the processor, memory, and a bridge 2608. The bridge interconnects the processor/memory bus 2606 with a high-speed data-input bus 2610 and an internal bus 2612 that connects the first bridge 2608 with a second bridge 2614. The second bridge is, in turn, connected to various devices 2616-2618 via high-speed communications media 2620. One of these devices is an I/O controller 2616 that controls a mass-storage device 2620.

Consider execution of the software program that implements a video codec. In this example, the software program is stored on the mass-storage device 2620 and paged, on an as-needed basis, into memory 2604. Instructions of the software program must be fetched, by the processor 2602, from memory for execution. Thus, execution of each instruction involves at least a memory fetch, and may also involve access, by the processor, to stored data in memory and ultimately in the mass-storage device 2620. A large percentage of the actual computational activity in the general-purpose computer system is devoted to transferring data and program instructions between the mass-storage device, memory, and the processor. Furthermore, with a video camera or other data-input device producing large volumes of data at high data-transfer rates, there may be significant contention for both memory and the mass-storage device among the video camera and the processor. This contention may carry over to saturation of the various busses and bridges within the general computer system. In order to carry out real-time video compression and decompression using a software implementation of a video codec, a very large portion of the available computational resources and power consumed by the computer are devoted to data transfer and instruction transfer, rather than on actually carrying out compression and decompression. A parallel-processing approach can be anticipated as a possible approach to increasing computational throughput of a software-implemented video codec. However, in a general-computing system, properly decomposing the problem to take full advantage of multiple processing components is a far from trivial task, and may not solve, or may even exacerbate, contention for memory resources and exhaustion of data-transfer bandwidth within the computer system.

A next implementation of a camera and general-purpose computer system that might be considered would be to integrate the sensor, image signal processor (“ISP”), and video codec into an integrated circuit package and move the compression and decompression software implementation onto hardware, using any of various system-on-a-chip design methods. A system-on-a-chip-implementation of a video codec integrated with a sensor and ISP in a single integrated circuit, or monolithic chip, would offer certain advantages over image acquisition and processing offered by a typical camera and general-purpose computer system executing a software implementation of the video codec. In particular, image acquisition and image signal processing may be carried in one portion of the chip and compression and decompression may be carried in another portion of the same chip with program instructions stored on board, in flash memory, and various computational steps implemented in logic circuits rather than being implemented as sequential execution of instructions by a processor. The result would be a significant reduction in the overall amount of circuit board real-estate, or form factor, when compared to implementations with separate sensor, ISP, and video codec form factors; the image compression could be carried out in real time; and there would be a significant reduction in the pin count, latency, heat dissipation, and power consumption.

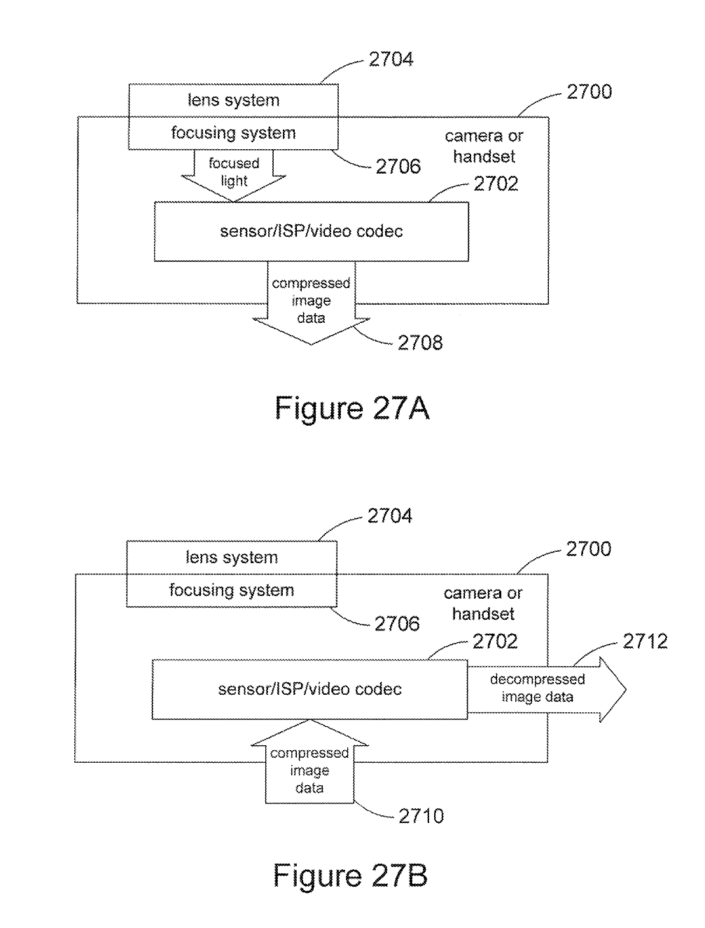

FIG. 27A illustrates a high-level schematic representation of a video acquisition and processing system employed in a video-camera system 2700 according to the present invention. The video-camera system 2700 can be implemented in a stand alone digital video camera or implemented in a handset, such as a cell phone, a smart phone, or other type of computational device. The camera system's 2700 video processing is performed in a video acquisition and processing system (“VAPS”) 2702 composed of a sensor, ISP, and video codec. The camera system 2700 can include other components (not shown) such as a battery for power supply and memory for storing compressed and uncompressed video data and other data. The camera system also includes a lens system 2704 and a focusing system 2706. Light reflected from objects in a scene is captured by the lens system 2704 and the lens adjusted by the focusing system 2706 to focus the light onto a sensor of the VAPS 2702. The sensor and ISP of the VAPS 2702 are configured to detect the captured light and perform image signal processing to generate image data in a suitable color model and format that can be compressed by the video codec of the VAPS. As shown in the example of FIG. 27A, the video codec of the VAPS 2702 outputs a compressed video-data stream 2708. As shown in FIG. 27B, the video codec of the VAPS 2702 can also be used to decompress a compressed video-data stream 2710 input to the camera system 2700 and output a decompressed video-data stream 2712.

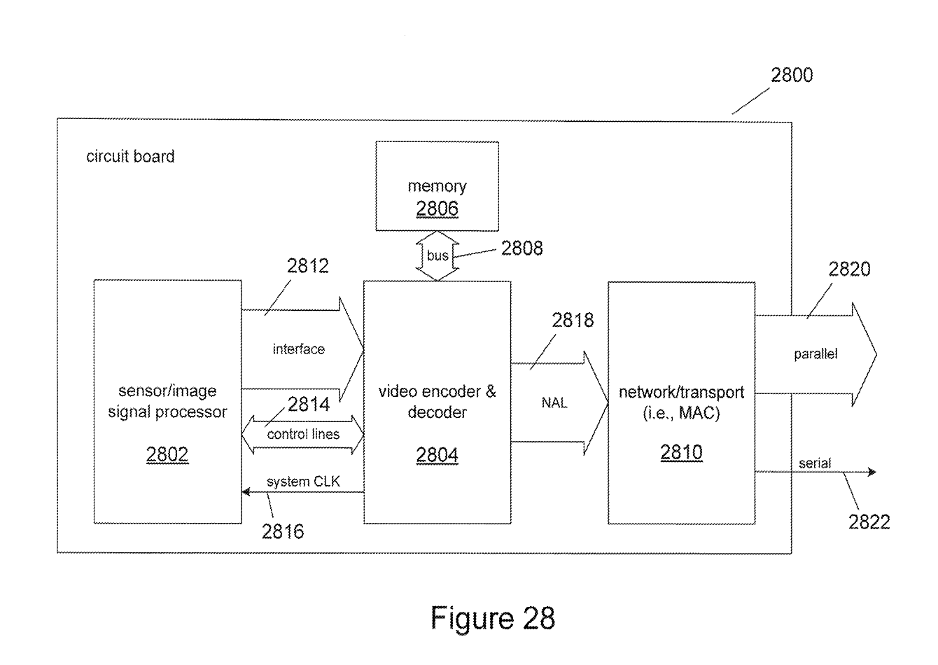

FIG. 28 illustrates a schematic representation of a VAPS 2800 configured according to the present invention. As shown in the example of FIG. 28, a sensor and ISP can be implemented in a sensor/ISP module in a first system-on-a-chip package 2802 and the video codec can be implemented in a separate second system-on-a-chip package 2804. The VAPS 2800 includes a separate memory 2806 connected to the video codec 2804 via bus 2808 and a network/transport chip 2810. The sensor portion of the sensor/ISP module 2802 generates raw video signals which are converted by the ISP portion of the sensor/ISP module 2802 into image data in a suitable color model and format, including, but not limited to, color models Y′CrCb or YUV in (4:4:4), (4:2:2), (4:2:0) formats, or regular RGB. The image data is sent from the sensor/ISP module 2802 over a data interface 2810 in parallel or serial to the video codec 2804 for processing as described below. The interface 2810 can be composed of bit lines printed on the circuit board, with the number of bit lines ranging from as few as about 6 bit lines to about 12 bit lines or up to even 70 or more bit lines. Control and synchronization data can be sent between the sensor/ISP module 2802 and the video codec 2804 over control signal lines 2814 ranging from as few 2 bit lines to about 6 bit lines or up to 12 or more bit lines. A clock signal line 2816 can be included for sending a system clock signal from the video codec 2804 to the sensor/ISP module 2802 in order to synchronize the image signal processing and image data generated by the sensor/ISP module with compression carried out by the video codec. The bus 2808 connecting the memory 2806 and the video codec 2804 can range from about 8 bit lines to about 16, 32, 64, or 128 bit lines or other suitable numbers of bit lines. As described above with reference to FIG. 5, the video codec 2804 outputs a compressed video-data stream of network-abstraction-layer (“NAL”) packets over an interface 2818 to the network/transport 2810, with the number of bit lines ranging from as few as about 6 bit lines to 70 or more bit lines. The network/transport 2810 can be implemented with multiplexed analog components (“MAC”) and the compressed video-data stream can be output in any suitable parallel 2820 or serial 2822 structure, such as using Ethernet packets or in a suitable form for transmission over a universal serial bus (“USB”).

Tables I-IV represent approximate pin counts, approximate power consumption, and approximate form factors associated with the components of the YAPS 2800. Table I represents ranges for approximate pin counts and approximate power consumption of the sensor/ISP module 2802 according to the present invention:

TABLE I

| Process technology (nm) | 65 | 40 | 32 | 20 |
|---|---|---|---|---|
| Pin count | 40-90 | 40-90 | 40-90 | 40-90 |
| Power (mW) | 300-720 | 180-450 | 100-220 | 40-150 |
| Form factor (mm²) | 90-160 | 50-150 | 30-120 | 25-100 |

The process technology refers to a manufacturing processes used in volume CMOS semiconductor fabrication. For example, 65 nm process technology is a lithographic process that may yield a gate length of about 35 nanometers and a gate oxide thickness of about 1.2 nanometers. Table I reveals that for the sensor/ISP module 2802 configured in accordance with embodiments of the present invention, the pin count for connecting the sensor/ISP module 2802 to the video codec 2804 can range from about 40 to 90 pins and the range of power consumption decreases with process technology. For example, power consumption of the sensor/ISP module fabricated with 65 nm process technology is estimated at about 300-720 milliwatts, while a sensor/ISP module fabricated with 20 nm process technology is estimated to have a power consumption of about 40-150 milliwatts.

Table II represents ranges for approximate pin counts, approximate power consumption, and approximate form factor dimensions of the memory 2806:

TABLE II

| Process/technology (nm) | 65 | 40 | 32 | 20 |
|---|---|---|---|---|
| Pin count | 8-160 | 8-160 | 8-160 | 8-160 |
| Power (mW) | 280-550 | 170-320 | 80-170 | 50-110 |
| Form factor (mm²) | 90-160 | 50-150 | 25-100 | 20-80 |

The approximate pin count for the network/transport chip 2810 can range from about 6 to about 90 pins.

Table III represents ranges for approximate pin counts, approximate power consumption, and approximate form factor dimensions of the video codec 2804:

TABLE III

| Process/technology (nm) | 65 | 40 | 32 | 20 |
|---|---|---|---|---|
| Pin count | 50-500 | 50-500 | 50-500 | 50-500 |
| Power (mW) | 180-720 | 90-550 | 70-350 | 40-200 |
| Form factor (mm²) | 80-170 | 50-120 | 50-110 | 40-110 |

Table IV represents ranges for approximate pin counts, approximate power consumption, and approximate form factor dimensions of the VAPS 2800:

TABLE IV

| Process/technology (nm) | 65 | 40 | 32 | 20 |
|---|---|---|---|---|
| Pin count | 120-750 | 120-750 | 120-750 | 120-750 |
| Power (mW) | 1100-2200 | 700-1300 | 400-750 | 200-450 |
| Form factor (mm²) | 250-500 | 180-400 | 160-350 | 150-300 |

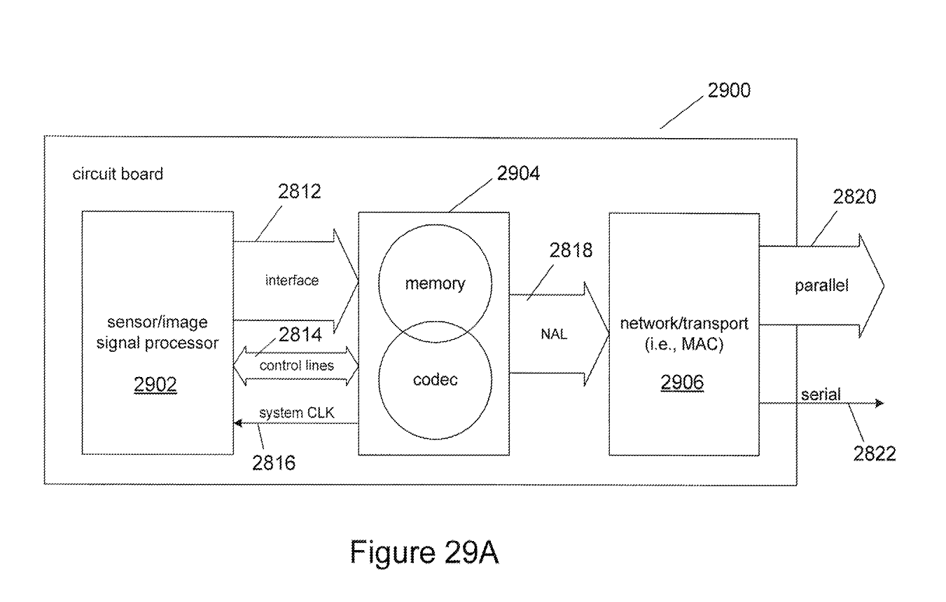

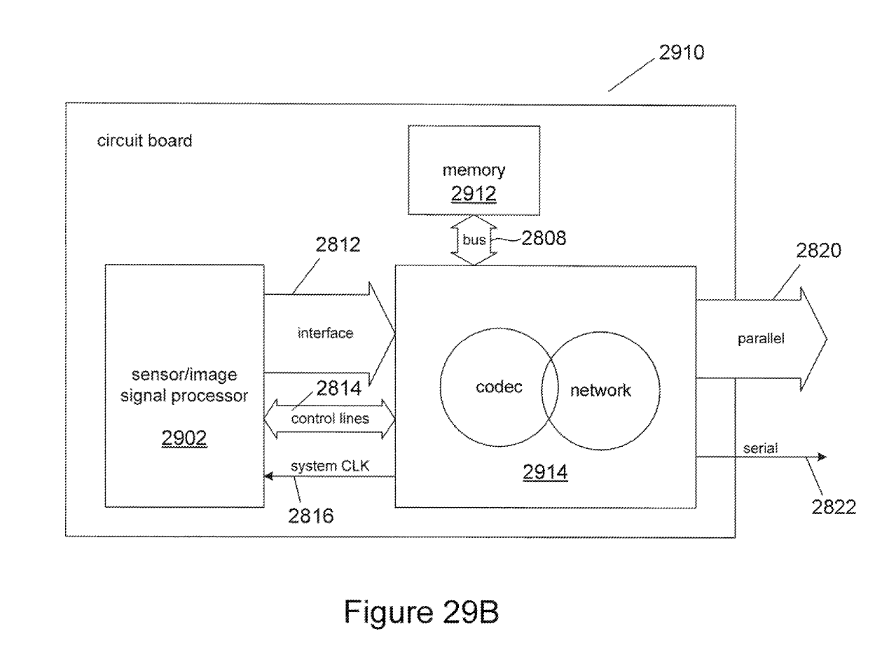

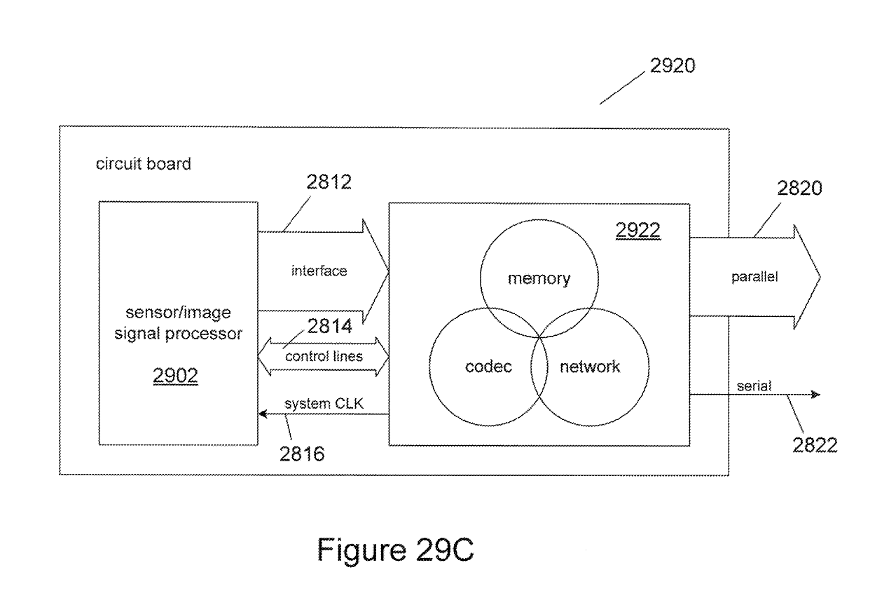

In order to further reduce the pin count, power consumption, and heat dissipation, the number of separate chips of the VAPS 2800 can be reduced by integrating the functionality of two or more separate chips into single integrated circuits. FIG. 29A illustrates a schematic representation of a VAPS 2900 with a sensor/ISP module 2902, a video codec 2904, and a network/transport chip 2906. As shown in the example of FIG. 29A, the memory implemented as a separate chip for the VAPS 2800, shown in FIG. 28, is integrated with the video codec 2904 for the VAPS 2900. By integrated the memory and the video codec into a single chip 2904, the bus 2808, shown in FIG. 28, is eliminated, the pin count associated with connecting the memory to the video codec is reduced to “0,” and the pin count of the video codec 2904 is less than the pin count of the video codec 2804. In other words, the pin count of the video codec 2904 can be reduced by about 8 to about 160 pins. Thus, the approximate pin count for the video codec 2904 can range from about 40 to about 340 pins, depending on the number of signal lines making up the interfaces 2812, 2814, 2816, and 2818.

FIG. 29B illustrates a schematic representation of a VAPS 2910 with a sensor/ISP module 2902 and memory 2912 implemented as separate chips and the video codec and network/transport integrated into a single integrated circuit 2914. Integrating the video codec and network/transport into a single integrated circuit also reduces the pin count and power consumption when compared with the separate chip implementations described above with reference to FIG. 28. In particular, the NAL interface 2818, shown in FIG. 28, can be eliminated.

FIG. 29C shows a schematic representation of a VAPS 2920 with the sensor/ISP module 2902 implemented as a separate integrated circuit while the memory, video codec, and network/transport are integrated into a separate single integrated circuit 2922. In this embodiment, the pin count, power consumption, and heat dissipation are further reduced over the VAPSs 2800, 2900, and 2910. The video codec 2922 still retains about 40 to about 90 pins for electronic communication with the sensor/ISP module 2902 and about 10 to about 30 pins for parallel and serial interfaces 2820 and 2822. Thus, the total pin count for the video codec 2922 can range from approximately 40 to about 120 pins and power consumption for the video codec can range from about 40 to about 720 milliwatts or more, depending on the processor technology.

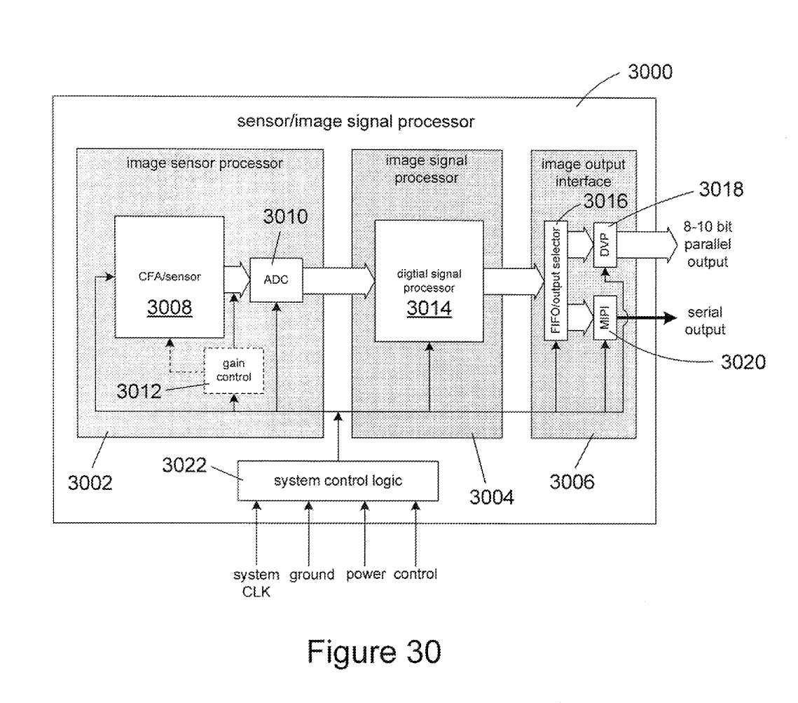

FIG. 30 illustrates a schematic diagram of a sensor/ISP module 3000 configured according to embodiments. The sensor/ISP module 300 includes an integrated image sensor processor 3002, image signal processor 3004, and image output interface 3006. The image sensor processor 3002 includes a sensor 3008, an analog-to-digital converter 3010, and a gain control 3012. The lens system 2704 and focusing system 2706, described above with reference to FIG. 27A, focus light onto the sensor 3008. The image signal processor 3004 includes a digital signal processor 3014. The image output interface 3006 includes a first-in-first-out (“FIFO”) output selector 3016, a digital video port (“DVP”) 3018, and a mobile industry processor interface (“MIPI”) 3020. System control logic 3022 controls the sensor 3008, the image sensor processor 3004, and the image output interface 3006. Raw video signals are generated by the image sensor processor 3002 and sent to the image signal processor 3004. The image signal processor 3004, in addition to performing other signal processing functions described below, converts the raw video signals into regular RGB image data, YUV image data, Y′CrCb image data or image data in another suitable color model and sends the processed image data to the image output interface 3006, where the processed image data can be buffered and sent to the video codec for further processing in a parallel or a serial structure, as described below.

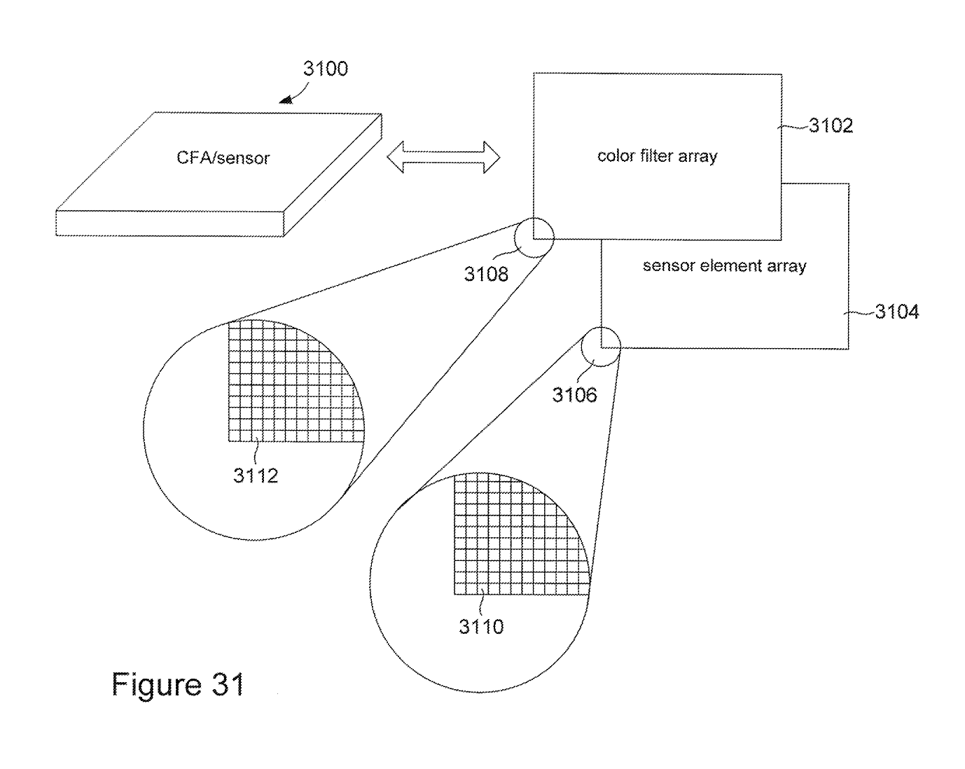

FIG. 31 illustrates an exploded isometric view of a sensor 3100 configured according to the present invention. The sensor 3100 includes a color filter array (“CFA”) 3102 and a sensor element array 3104. The sensor element array 3104 is composed of an array of sensor elements, or photo cells, and the CFA is composed of an array of red (“R”), green (“G”), or blue (“B”) color filter, with each color filter of the CFA aligned with a sensor element of the sensor element array. As shown in the example of FIG. 31, a small portion 3106 of a corner of the sensor element array 3104 is magnified, and a corresponding small portion 3108 of a corner of the CFA 3102 is magnified. The magnification of the corner 3106 reveals that the sensor element array is divided into small squares, such as square 3110, corresponding to, or representing, a single sensor element. The magnification of corner 3108 also reveals that the CFA is divided into small squares, such as square 3112, each square corresponding to a single R, G, or B color filter. CFA and sensor element arrays can be composed of 1280×720 color filters and corresponding sensor elements, or the CFA and sensor element array be composed of 1920×1080 color filters and corresponding sensor elements. Embodiments of the present invention are not limited to CFAs and sensor element arrays having either 1280×720 or 1920×1080 filters or sensor elements. In other embodiments, CFAs and sensor element arrays can be configured with any number of filters and sensor elements.

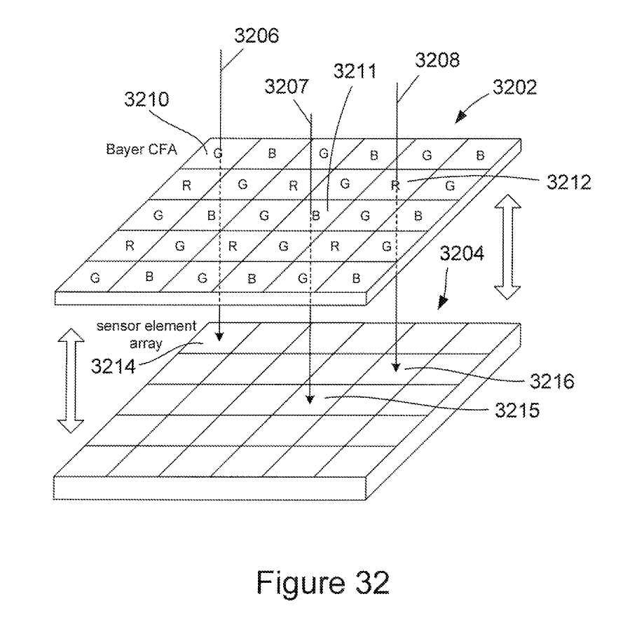

FIG. 32 illustrates an exploded isometric view of a portion 3202 of a CFA and a corresponding portion 3204 of a sensor element array according to the present invention. As shown in the example of FIG. 32, the CFA 3202 is configured as a Bayer filter 3202. A Bayer filter is composed RGB color filters where half the number of filters are G filters, and one-quarter of the total number of filters are R and B filters. In other words, there are twice as many G filters as there are R and B filters in order to mimic the human eye's greater resolving power with green light. The color filters are arranged with alternating R and G filters for odd rows and alternating G and B filters for even rows. Light represented by rays 3206-3208 passes through each of the color filters 3210-3212 to corresponding sensor elements 3214-3216 below. When exposed to light, each sensor element accumulates a signal charge proportional to the illumination intensity of the light striking the sensor element. The CFA can also be configured with microlenses (not shown) at each color filter in order to focus the light passing through each filter onto the corresponding sensor element in order to reduce loss. Note that embodiments of the present invention are not limited to sensors with Bayer CFA's. The Bayer CFA 3210 is a commonly used CFA and is only provided by way of example. In other embodiments, the CFA can be composed of other RGB color filter arrangements or different types of color filters, such as cyan, magenta, and yellow color filters.

In certain embodiments, the sensor element array 3104 can be composed of an array of charge-coupled device (“CCD”) sensor elements. CCD sensor elements are analog shift registers that enable the movement of electric charges through successive capacitor stages, are controlled by a clock signal, and can be used to serialize parallel analog signals. In other embodiments, the sensor element array 3104 can be composed of an array of complementary metal-oxide semiconductor (“CMOS”) sensor elements. Typically, each CMOS sensor element outputs a voltage and includes an amplifier that amplifies the voltage. The sensor elements can range in size from about 1.6 μm² to about 6 μm². Power consumption ranges from about 100 mW to about 600 mW for sensor element arrays ranging in size about 1 megapixel to about 9 megapixels. Embodiments of the present invention are not limited to sensor element arrays where the number of pixels range from between 1 megapixel to 9 megapixels. The sensor array elements can be configured with a larger number of pixels and include high-definition resolution.

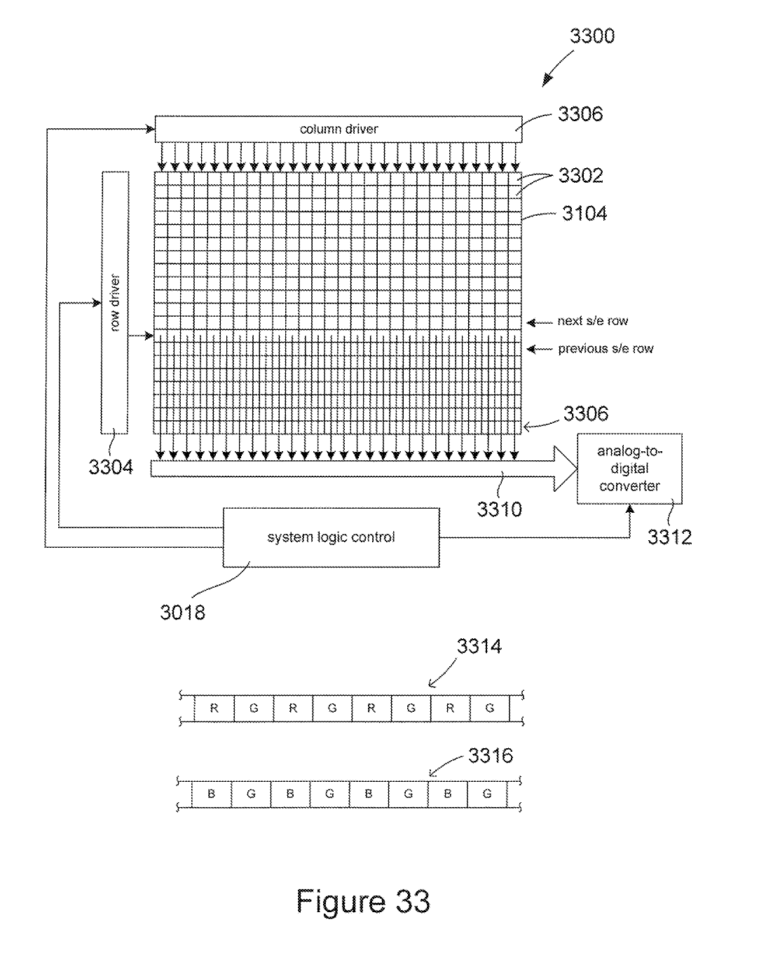

FIG. 33 illustrates a diagram of a sensor 3300 operated in accordance with embodiments of the present invention. Squares 3302 represent sensor elements of the sensor element array 3104. When exposure of the sensor to light for a period of time is complete, the system logic control 3018 drives the row driver 3304 and column driver 3306 so that each CCD sensor element transfers a charge packet sequentially to the sensor element in the row directly beneath, until the bottom row 3308 is reached where each CCD sensor element in the bottom row is sent 3310 to an output structure that coverts each charge to voltage and sends it to an analog-to-digital converter 3312. With a CMOS sensor 3300, the charge-to-voltage conversion may take place at each sensor element and voltages are also driven row-by-row to the analog-to-digital converter. FIG. 33 includes a sequence of boxes 3314, each box representing a voltage associated with sensor elements in a row of R and G filters sent from the sensor to the analog-to-digital converter 3312 for a Bayer CFA. Sequence of boxes 3316 represent voltages associated with sensor elements in a subsequent row of alternating G and B filters of the same Bayer CFA sent to the analog-to-digital converter 3312.

Gain control, such as the gain control 3012 shown in FIG. 30, can be used to amplify the voltage output from each of the sensor elements when the sensor is configured with CMOS sensor elements, or when the sensor is configured with CCD sensor elements, the gain control 3012 can be used to amplify the analog voltages output from the sensor prior to the voltages reaching the analog-to-digital converter 3010. Also shown in FIG. 30 is the analog-to-digital converter 3010, which converts the analog voltages, output from sensor into discrete voltages. The digital signal processor 3020 can perform white balancing and color correlation to ensure proper color fidelity in captured images. Because the sensor 3008 does not detect light in the same way as the human eye, white balancing and correlation may be necessary to ensure that the final image represents the colors of the original captured scene. A white object has equal values of reflectivity for each of the RGB color values. An image of a white object can be captured and its histogram analyzed. The color value with the largest level is set as the target mean and the remaining two color values are increased with gain multipliers. The digital signal processor 3020 can also perform, filtering, frame cropping, denoising, deflickering, and other suitable image manipulation functions.

In certain embodiments, each sensor element of a sensor may correspond to a pixel in a frame of a color image obtained from the sensor. However, an RGB pixel is composed of the three primary R, G, and B color values, as described above with reference to FIG. 2, and, as described above with reference to FIG. 33, reading sensor elements of the sensor generates for each sensor element only one of the primary colors R, G, or B. For example, as described above with reference to FIG. 33, the voltage output from each of the sensor elements corresponds to the intensity of the light that passed through one of a corresponding R filter, a G filter, or a B filter. Thus, the raw video signals output from the image sensor processor represents a series of color values, each color value is associated with one sensor element and provides only one of the three RGB color values for a corresponding pixel. In order to determine the other two color values associated with each pixel, the raw video signals are sent to the digital signal processor 3020 where the remaining two color values for each pixel can be interpolated in a process also called “demosaicing.”

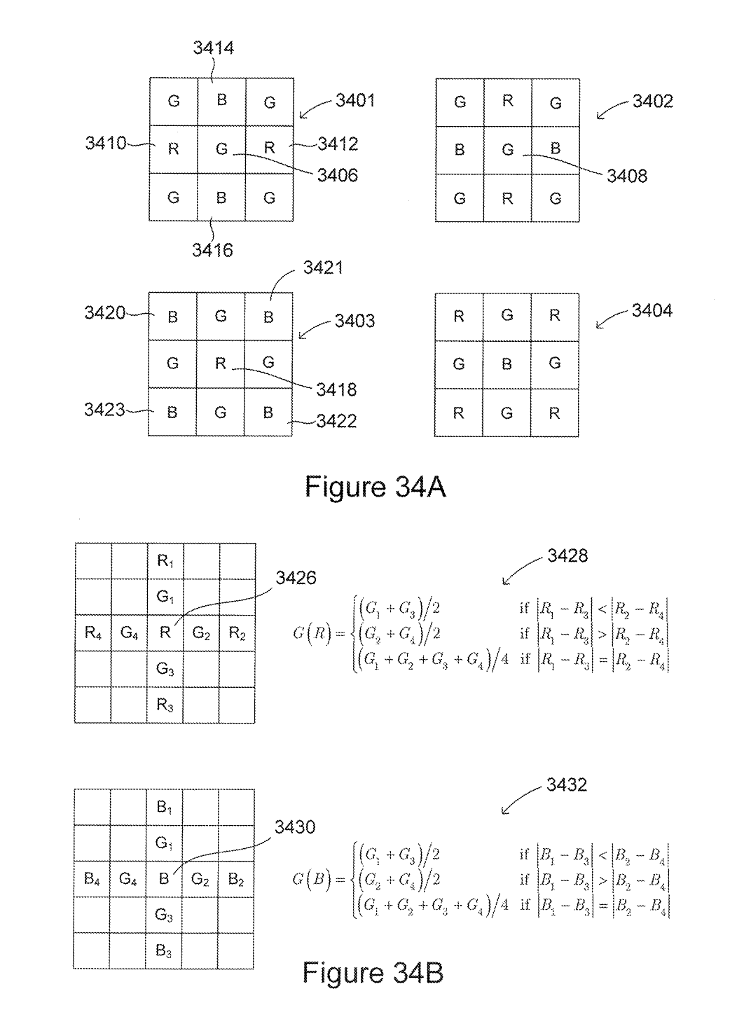

FIG. 34A illustrates four possible cases for interpolating R and B color values from the color values of nearest neighboring pixels according to the present invention. Squares in 3×3 matrices 3401-3404 represent neighboring pixels, each pixel with one raw color value obtained from a corresponding sensor element of the sensor. The missing R and B color values on green pixels 3406 and 3407 can be determined by averaging values of the two nearest neighboring pixels of the same color. For example, the R color value of the pixel 3406 can be determined by averaging the color values of the nearest neighboring R pixels 3410 and 3412, and the B color value of the pixel 3406 can be determined by averaging the color values of the nearest neighboring B pixels 3414 and 3416. Pixel matrix 3403 shows the case where the blue pixel value of the pixel 3418 can be determined by averaging the B color values of the nearest neighbor pixels 3420-3423 with B color values. FIG. 34B illustrates two cases for interpolating G color values for pixels with R and B color values form the color values of nearest neighboring pixels according to the present invention. Squares in 5×5 matrices 3401-3404 represent neighboring pixels, each pixel with one raw color value obtained from a corresponding sensor element of the sensor. The G color value can be interpolated on the pixel 3426 with R color value according to adaptive interpolation 3428. The G color value can be interpolated on the pixel 3430 with B color value according to adaptive interpolation 3432.

In other embodiments, each pixel in a frame may be a function of a number of neighboring pixels on the sensor same color and is not limited by sensor resolution. In other words, for a given sensor, each pixel may be determined by upsampling or downsampling the sensor data. Thus embodiments of the present invention are not limited to interpolation as described above with reference to FIG. 34. Interpolation is a commonly used technique and there exits numerous different interpolation techniques for determining regular RGB. The description of interpolation with regard to FIG. 34 is provided only as an example of one type of interpolation method that can be performed in accordance with embodiments of the present invention.

Returning to FIG. 30, after the RGB for each pixel has been determined, the digital signal processor 3020 can convert each regular RGB pixel to another suitable color model for processing by the video codec 2710, including YUV or Y′CrCb in (4:4:4), (4:2:2), or (4:2:0) formats, as described above with reference to FIGS. 2 and 3. The image data can then be sent to the image output interface 3006. In other embodiments, the digital signal processor 3020 can process the image to arrive at the image output interface 3006 in macroblocks. The selector 3022 includes a buffer for temporary storage of the image data and the output can be preselected by an operator to output the image data in a parallel or a serial format over the interface 2802 by directing the image data stored in the selector 3022 to the DVP 3024 or the MIPI 3026. The image output interface 3006 can then output the image data to the video codec in any suitable format, such as macroblocks.

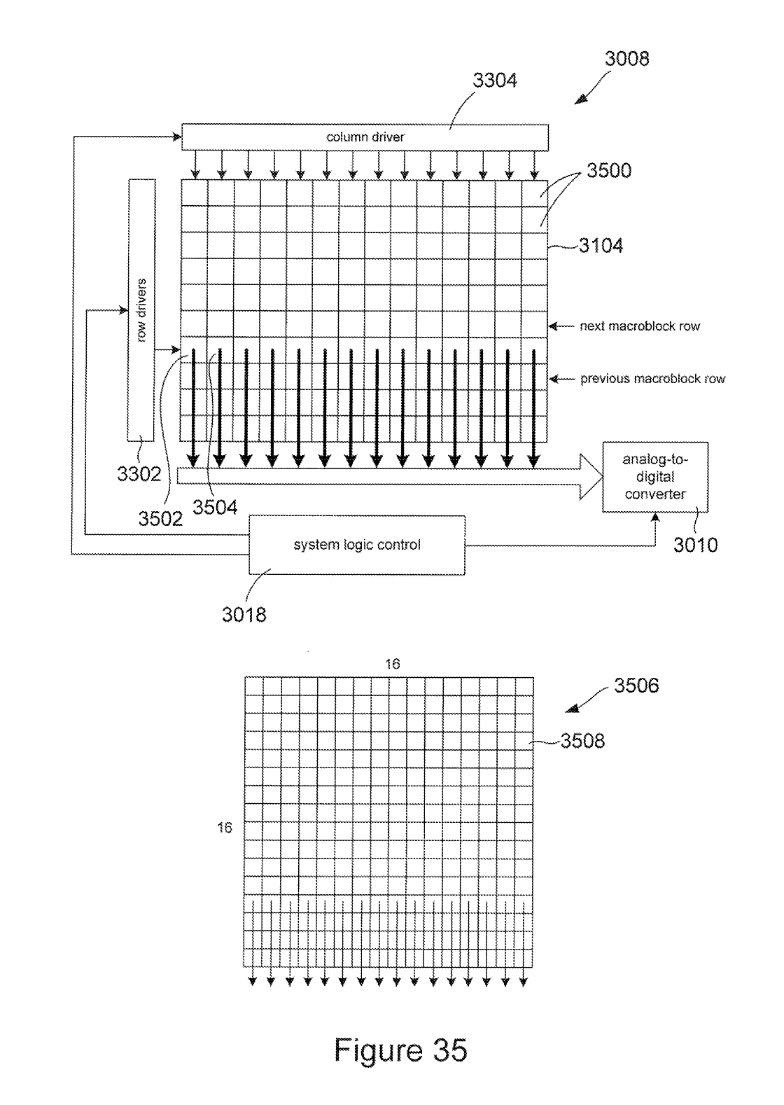

In other embodiments, rather than processing and retrieving the charges or voltages stored in the sensor elements row-by-row of the sensor 3008, as described above with reference to FIG. 33, the charges or voltages associated with each of the sensor elements can be retrieved and processed in rows of macroblocks. FIG. 35 illustrates a diagram of the sensor 3008 operated to retrieve rows of macroblocks in accordance with embodiments of the present invention. Squares 3500 represent macroblocks of the sensor element array 3104. When exposure of the sensor to light for a period of time is complete, the system logic control 3018 drives the row driver 3302 and column driver 3304 so that the sensor elements of each macroblock, within a row of macroblocks, is output to the analog-to-digital converter 3010. For example, the sensor elements of the macroblock 3502 can be sent to the analog-to-digital converter followed by the macroblock 3504 in the same row and so on. The next row of macroblocks can be processed in the same manner. FIG. 35 also includes an enlargement of a macroblock 3506 where each square, such as square 3508, represents a sensor element of the sensor element array 3104. Each macroblock is separately processed by retrieving the charges or voltages in each row of sensor elements, and the charge or voltages are sent row-by-row within a macroblock to the analog-to-digital converter 3010. FIG. 35 represents only one way in which macroblocks can be retrieved. Embodiments of the present invention include other ways of retrieving the raw video signals using macroblocks.

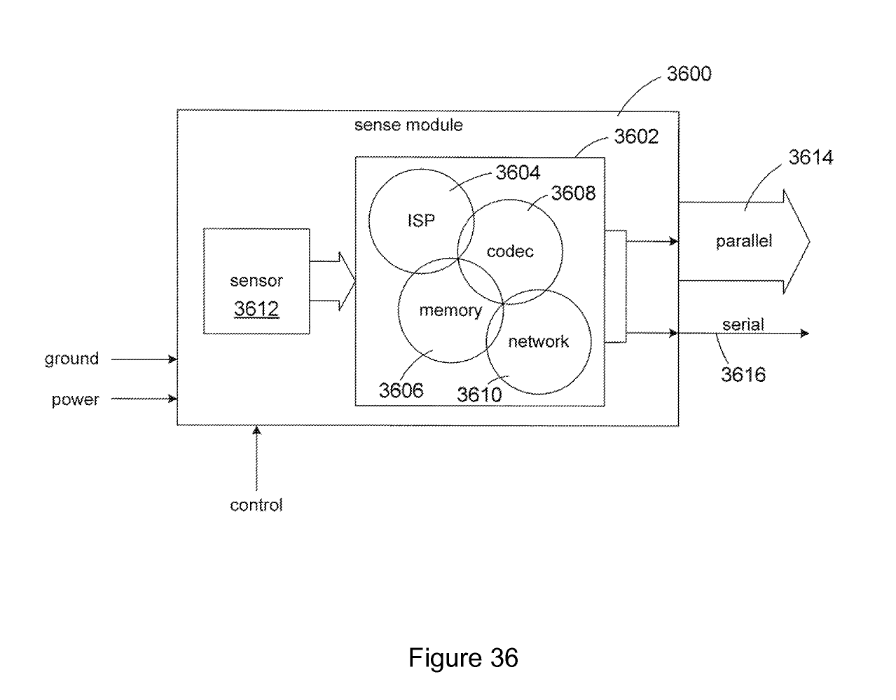

Embodiments of the present invention include sense modules composed of a sensor packaged with a single integrated circuit that performs image signal processing, video compression and decompression, and network/transport. FIG. 36 illustrates a schematic representation of a sense module 3600 configured according to the present invention. As shown in the example of FIG. 36, the sense module includes a sensor 3602 and an integrated circuit 3604 that are packaged to operate as a single integrated circuit. The integrated circuit 3604 performs the operation of image signals processing 3606, includes memory 3608, performs video compression and decompression 3610, and includes network/transport functionality 3612 all of which are fully integrated in order to reduce pin count, power consumption, latency, and heat dissipation. The sensor 3602 acquires an image and transmits image as raw video signals to the integrated circuit 3604 which performs in real time image signal processing, video compression, image data storage, and outputs a compressed video-data stream in either a parallel structure 3614 or serial structure 3616, such as in Ethernet packets or USB. The sense module allows for massively parallel processing of raw image data to produce compressed image data for transmission in any serial or parallel bus structure and with any transport level standard.

Table V represents ranges for total pin counts and approximate power consumption of the sense module 3100 for various process technology feature sizes:

TABLE V

| Process/technology (nm) | 65 | 40 | 32 | 20 |
|---|---|---|---|---|
| Pin count | 40-100 | 40-100 | 40-100 | 40-100 |
| Power (mW) | 250-900 | 150-600 | 50-300 | 20-200 |
| Form factor (mm²) | 80-150 | 60-130 | 40-120 | 30-100 |

Note that the sense module with fully integrated sensor, ISP, memory, and network/transport has a form factor, total pin count range and power consumption that substantially matches the form factor, pin count, and power consumption of the sensor/ISP module described above with reference to FIGS. 28 and 30. In particular, the pin count for interconnecting the ISP, video codec, and memory is “0.”

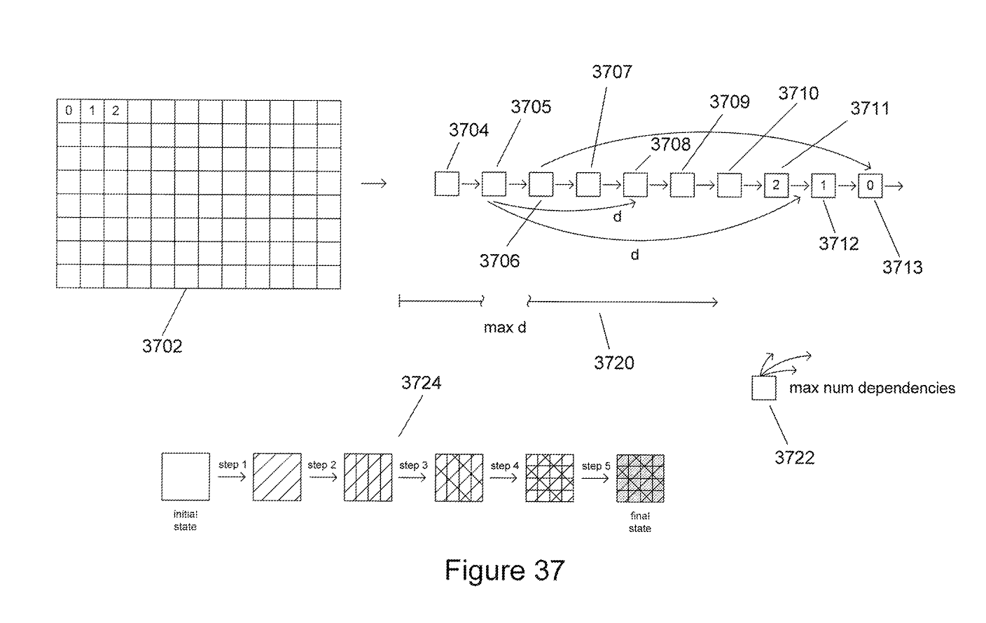

Y′CrCb or YUV image data in the (4:4:4), (4:2:2), or (4:2:0) formats, or regular RGB format, is sent to the video codec for compression in accordance with the description associated with FIGS. 6-24. FIG. 37 illustrates a number of aspects of the video compression and decompression process that, when considered, provide insight into a new, and far more computationally efficient, approach to implementation of a video codec according to the present invention. First, the H.264 standard has provided for a high-level problem decomposition amenable to a parallel-processing solution. As discussed above, each video frame 3702 is decomposed into macroblocks 3704-3713, and macroblock-based or macroblock-partition-based operations are performed on macroblocks and macroblock partitions in order to compress a video frame, in the forward direction, and macroblocks are decompressed, in the reverse, decompression direction, to reconstitute decompressed frames. Certainly, as discussed above, there are dependencies between frames and between macroblocks during the encoding process and during the decoding process. However, as shown in FIG. 37, the macroblock-to-macroblock and macroblock-partition-to-macroblock-partition dependencies are generally forward dependencies. The initial macroblock in an initial frame of a sequence 3713 does not depend on subsequent macroblocks, and can be compressed based entirely on its own contents. As compression continues, frame-by-frame, via a raster-scan processing of macroblocks, subsequent macroblocks may depend on macroblocks in previously compressed frames, particularly for inter prediction, and may depend on previously compressed macroblocks within the same frame, particularly for intra prediction. However, the dependencies are well constrained. First, the dependencies are bounded by a maximum distance in sequence, space, and time 3720. In other words, only adjacent macroblocks within the current frame and macroblocks within a search area centered at the position of the current frame in a relatively small number of reference frames may possibly contribute to compressing any given macroblock. Were the dependencies not well constrained in time, space, and sequence, very large memory capacity would be required to contain intermediate results needed for compressing successive macroblocks. Such memories are expensive, and quickly begin to consume available computational bandwidth as memory-management tasks grow in complexity and size. Another type of constraint is that there are only a relatively small, maximum number of dependencies possible for a given macroblock 3722. This constraint also contributes to bounding the necessary size of memory, and contributes to a bound on computational complexity. As the number of dependencies grows, the computational complexity may grow geometrically or exponentially. Furthermore, parallel processing solutions to complex computational problems are only feasible and manageable when the necessary communications between processing entities is well bounded. Otherwise, communication of results between discrete processing entities quickly overwhelms the available computational bandwidth. Another characteristic of the video-codec problem is that processing of each macroblock, either in the forward, compression direction or in the reverse, decompression direction, is a stepwise process 3724. As discussed above, these sequential steps include inter and intra prediction, generation of residual macroblocks, major transform, quantization, object re-ordering, and entropy encoding. These steps are discrete, and, in general, the results of one step are fed directly into the following step. Thus, macroblocks can be processed in assembly-line fashion by the video codec, just as cars or appliances can be manufactured in stepwise fashion along assembly lines.

The characteristics of video-codec implementation, discussed with reference to FIG. 37, that motivate the massively parallel-processing implementation of a video codec according to the present invention may be present within many different problem domains. In many cases, a computational problem can be decomposed in many different ways. In order to apply the methods of the present invention to any particular problem, a problem decomposition that produces some or all of the characteristics discussed above with reference to FIG. 37 needs to be selected, as a first step of the method. For example, the video-data-stream compression problem can be decomposed in alternative, unfavorable ways. For example, an alternative decomposition would be to analyze the entire video data stream, or significant blocks of frames, for motion detection in advance of macroblock processing. In certain respects, this larger granularity approach might provide significant advantages with respect to motion detection and motion-detection-based compression. However, this alternative problem decomposition requires significantly greater internal memory, and the motion-detection step would be too complex and computationally inefficient to be easily accommodated within a stepwise processing of computationally tractable and manageable data objects.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A video acquisition and processing system comprising:
a sensor;
an image signal processor, the sensor and image signal processor arranged so that the sensor converts detected light into raw image data, the raw image data subsequently converted by the image signal processor into image data having a particular color model and format, the image data comprising one or more video frames, and each video frame comprising luma and chroma macroblocks, wherein the color model and format comprise distinct luma and chroma values and wherein each of the luma macroblocks comprises a plurality of the luma values and each of the chroma macroblocks comprises a plurality of the chroma values;
video compression and decompression component arranged to receive the image data output based on parallel transmission from the image signal processor and convert the image data into a compressed video-data stream, the video compression and decompression component comprising a plurality of processing elements that operate concurrently for parallel computation, such that each of the luma and chroma macroblocks is processed in parallel and concurrently.

2. The system of claim 1 wherein the sensor and image signal processor are implemented in a first integrated circuit and the video compression and decompression component is implemented in a second integrated circuit.

3. The system of claim 2 wherein the first integrated circuit consumes 180 to 450 milliwatts when the first integrated circuit is fabricated with process technology of 40 nanometers.

4. The system of claim 2 wherein the first integrated circuit consumes 100 to 220 milliwatts when the first integrated circuit is fabricated with process technology of 32 nanometers.

5. The system of claim 2 wherein the first integrated circuit consumes 40 to 150 milliwatts when the first integrated circuit is fabricated with process technology of 20 nanometers.

6. The system of claim 2 wherein the second integrated circuit further comprises a pin count of 50 to 500 pins.

7. The system of claim 2 wherein the second integrated circuit consumes 180 to 720 milliwatts when the second integrated circuit is fabricated with process technology of 65 nanometers.

8. The system of claim 2 wherein the second integrated circuit consumes 90 to 550 milliwatts when the second integrated circuit is fabricated with process technology of 40 nanometers.

9. The system of claim 2 wherein the second integrated circuit consumes 70 to 350 milliwatts when the second integrated circuit is fabricated with process technology of 32 nanometers.

10. The system of claim 2 wherein the second integrated circuit consumes 40 to 200 milliwatts when the second integrated circuit is fabricated with process technology of 20 nanometers.

11. The system of claim 2 wherein the second integrated circuit is configured with a form factor ranging from 40 to 170 square millimeters.

12. The system of claim 2 wherein the first integrated circuit further comprises an image output interface for sending image data in the color model and format output to the video compression and decompression component.

13. The system of claim 1 further comprising a network/transport for sending compressed image data output from the video compression and decompression component in a parallel or a serial structure.

14. The system of claim 13 wherein the compressed video-data stream is output in Ethernet packets.

15. The system of claim 13 wherein the compressed video-data stream is output in at least one of a parallel data stream or a serial data stream.

16. The system of claim 1 wherein the image signal processor further comprises a digital signal processor.

17. The system of claim 1 wherein raw image data is output from the sensor to the image signal processor in macroblocks.

18. The system of claim 1 wherein the video compression and decompression component is configured to receive and decompress a compressed video-data stream.

19. A video acquisition and processing system comprising:
a sensor configured to convert detected light into raw image data; and
video compression and decompression component arranged to receive the raw image data from the sensor, subsequently convert the raw image data into image data having a particular color model and format, and convert the image data into a compressed video-data stream, the compressed video-data stream comprising one or more video frames, and each video frame comprising luma and chroma macroblocks, the color model and format comprising distinct luma and chroma values, each of the luma macroblocks comprising a plurality of the luma values and each of the chroma macroblocks comprising a plurality of the chroma values, the video compression and decompression component comprising a plurality of processing elements that operate concurrently for parallel computation, such that each of the luma and chroma macroblocks is processed in parallel and concurrently.

20. A video-camera system comprising:
a lens system for acquiring light reflected from a scene;
a focusing system for focusing the light;
a sensor and image signal processor, the sensor and image signal processor arranged so that the sensor converts detected light into raw image data, the raw image data subsequently converted by the image signal processor into image data having a particular color model and format, the image data comprising one or more video frames, and each video frame comprising luma and chroma macroblocks, wherein the color model and format comprise distinct luma and chroma values and wherein each of the luma macroblocks comprises a plurality of the luma values and each of the chroma macroblocks comprises a plurality of the chroma values; and
video compression and decompression component arranged to receive the image data based on parallel transmission from the image signal processor and output a compressed video-data stream, the video compression and decompression component comprising a plurality of processing elements that operate concurrently for parallel computation, such that each of the luma and chroma macroblocks is processed in parallel and concurrently.
